(19) United States
(12) Patent Application Publication
(10) Pub. No.: US 2022/0414466 A1
(43) Pub. Date: Dec. 29, 2022

(54) CONFIDENCE-BASED ASSISTED LEARNING

(71) Applicant: Regents of the University of Minnesota, Minneapolis, MN (US)

(72) Inventor: Jie Ding, Plymouth, MN (US)

(21) Appl. No.: 17/806,200

(22) Filed: Jun. 9, 2022

Related U.S. Application Data
(60) Provisional application No. 63/202,385, filed on Jun. 9, 2021.

(51) Int. Cl. G06N 3/08; G06N 3/04; G06K 9/62

(52) U.S. Cl. CPC G06N 3/08; G06N 3/0454; G06K 9/6256; G06K 9/6265

(57) ABSTRACT

Techniques are disclosed for assisted learning with enhanced privacy. A method comprises: sending first statistical information from a first agent to a second agent in an architecture having at least two agents, wherein a first set of sample weights correspond to training the first machine learning model, wherein the first statistical information comprises the second set of sample weights determined from a first model weight; receiving, from the second agent, second statistical information comprising the second model weight and updated first set of sample weights or, from a third agent of the architecture, third statistical information comprising a third model weight and a next iteration of the first set of sample weights; and updating the first machine learning model using the second statistical information or the third statistical information.

### PRIORITY CLAIM

This application claims the benefit of U.S. Provisional Application Ser. No. 63/202,385, filed Jun. 9, 2021, the entire content of which is incorporated herein by reference.

### GOVERNMENT RIGHTS

This invention was made with government support under W91NF-20-1-0222 awarded by US Army Research Office. The government has certain rights in the invention.

### TECHNICAL FIELD

This disclosure generally relates to machine learning architectures.

### BACKGROUND

Machine learning can often be defined as a data analysis technology for knowledge to be extracted by a machine, without any explicit definition to conduct the same, based on a series of observations. In general, machine learning refers to a number of scientific principles (e.g., pattern recognition principles) that determine if the machine is capable of learning from a data corpus and of reproducing repeatable actions with higher reliability and efficient decision making. In the era of big data with exploding size and complexity, machine learning technologies have successfully taken advantage of the richness of available data to facilitate industrial development and/or human experience. To illustrate the ubiquity of machine learning, mobile applications frequently make suggestions to users based on previous searches of the user. As one example, a mobile application may suggest a restaurant based upon previous user searches.

A machine learning architecture, in general, refers to an artificial intelligence platform from which a number of machines learn from each other and/or from external sources. The basic idea is to train machines on how to learn and make decisions without explicit inputs from users. In this architecture, one machine may play the role of a user while another machine may play the role of a service such that the user machine receives some intelligence from the service machine. The effectiveness of a conventional machine learning architecture often depends upon the richness of the corpus of training data.

### SUMMARY

In general, the present disclosure describes techniques for assisted learning in a machine learning architecture. In some examples, the present disclosure describes different entities (i.e., agents) building their own local models within an assisted learning framework and, for their mutual benefit, sharing valuable intelligence learned or gained from building these models. As described herein, technologies implementing the techniques described herein may achieve a level of data privacy beyond what is possible in conventional machine learning architectures, without sacrificing quality of any gained intelligence. Therefore, two or more agents engaged in assisted learning may exchange their gained intelligence without disclosing sensitive or private user data and in some instances, achieve a reduction in a total build time for any agent's local model.

Successful conventional machine learning architectures provide intelligence from user data sets but often require disclosure of that data. Concerns of data security and privacy have led to more stringent regulations on the use of data in machine learning. There is considerable interest in designing machine learning architectures that facilitate not only accuracy, but also privacy and data security. In addition, there is also a growing demand for protecting the agents that manage data.

The assisted learning techniques for the machine learning architecture, as described herein, may provide one or more technical advantages or improvements in form of at least one practical application. The techniques enable data privacy (e.g., module or model privacy) which, instead of protecting the data alone, protects the privacy of proprietary data and a model as a black-box (e.g., module). Some techniques also enable other aspects of data privacy such as differential privacy (e.g., where differences between proprietary datasets are protected) and/or objective privacy (e.g., where a goal of the model or learner unit is protected). These techniques also improve upon a learning quality of a learner unit. Some techniques utilize a simple linear regression algorithm to train and construct a machine learning model and a learner unit (e.g., a learner unit function).

In the context of a machine learning architecture having a network of remote computing devices operating as modules, the techniques described herein introduce a new level of privacy that protects not only data but also algorithms for each learner unit in a network of learner units. Each learner unit can choose to assist others, or each learner unit receives assistance from others, where the assistance is realized by iterative communications of essential statistics. The communication protocol for assisted learning is designed in a way that protects both types of learner units and benefit the learning performance. The machine learning architecture also leads to a new concept of a machine learning market, which includes learner units and assisting communications (possibly for rewards).

In one example, this disclosure describes a method that includes: by processing circuitry of a computing device, sending first statistical information from a first agent to a second agent in an architecture having at least two agents, wherein a first machine learning model is configured to map a first feature set to a first label set and the first agent is configured to train the first machine learning model to predict an observed label set, wherein a first set of sample weights correspond to training the first machine learning model, wherein the first set of sample weights determine a first model weight for fitting the first label set with the observed label set based on a first learning technique and the first machine learning model, wherein the first set of sample weights and the first model weight determine a second set of sample weights corresponding to training a second machine learning model at the second agent, wherein the first statistical information comprises the second set of sample weights, wherein the second agent receives the first statistical information comprising the second set of sample weights and comprises the second machine learning model configured to map a second feature set to a second label set, wherein the second agent is configured to determine a second model weight for fitting, into the observed label set, the second label set based on a second learning technique, the second machine learning model, and the first statistical information, wherein the second agent is further configured to update the first set of sample weights based on the second model weight and the second set of sample weights, wherein the second agent executes on at least one computing system; by the processing circuitry of the computing device, receiving, from the second agent, second statistical information comprising the second model weight and the updated first set of sample weights or, from a third agent of the architecture, third statistical information comprising a third model weight and a next iteration of the first set of sample weights, wherein the third model weight is derived from the first statistical information and the second statistical information; and updating, by the processing circuitry of the computing device, the first machine learning model using the second statistical information or the third statistical information, wherein the updated machine learning model is configured to map the first feature set to an updated first label set based on the updated first set of sample weights or the next iteration of the first set of sample weights.

In yet another example, the disclosure describes a computing device for an agent of an assisted learning architecture comprising: processing circuitry coupled to memory and configured to: execute a training process on a machine learning model by exchanging, with at least one other agent of the assisted learning architecture, iterations of confidence scores, wherein the at least one other agent is configured to train at least one other machine learning model, wherein for each iteration, the training process determines a set of sample weights as the confidence scores for the machine learning model and communicates, to a second agent of the at least one agent, a second set of sample weights as the confidence scores for a second machine learning model of the at least one other machine learning model, wherein the confidence scores for the machine learning model corresponds to a progress level in the training process and the confidence scores for the second machine learning model correspond to a progress level in training the second machine learning model when compared to the progress level in training the machine learning model, and the second agent updates the set of sample weights in response to further training the second machine learning model and returns, to the agent for a next iteration of the confidence scores for the machine learning model, the updated set of sample weights and a model weight determined from the confidence scores of the second machine learning model.

In another example, this disclosure describes a non-transitory computer-readable medium comprising instructions to implement any method described herein, which when executed by processing circuitry, cause a computing device to perform the method described herein.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIGS. 1A-B are block diagrams illustrating example architectures having agents to exchange statistical information and build machine learning models, in accordance with one or more techniques of the disclosure.

FIG. 2 is a block diagram illustrating an example computing device within one or more of the example architectures of FIGS. 1A and/or 1B, in accordance with one or more techniques of the disclosure.

FIG. 3 is a flowchart illustrating an example operation by a computing device of the example architecture of FIG. 1A or 1B, in accordance with one or more techniques of the disclosure.

FIG. 4A and FIG. 4B are both block diagrams illustrating a two-agent scenario and a multi-agent scenario of confidence-based assisted learning in an example architecture of FIG. 1A or 1B, in accordance with one or more techniques of the disclosure.

FIG. 5 is an illustration of a two-stage assisted learning protocol for an example architecture of FIG. 1A or 1B, in accordance with one or more techniques of the disclosure.

FIG. 6 is an illustration of a multi-agent example for example architecture of FIG. 1A or 1B, in accordance with one or more techniques of the disclosure.

Like reference characters refer to like elements throughout the figures and description.

### DETAILED DESCRIPTION

Conventional machine learning architectures provide intelligence from user data but at the cost of disclosing at least some of that data. Typically, a machine learning architecture transmits user data to a data center for further processing. In some cases, an adversary can deduce elements of the user data by requesting certain services related to that data. For at least this reason, conventional architectures achieve technological advancement at the cost of data privacy. This can be a hindrance for both service providers and users (e.g., data analysts), since transmitting user data requires sophisticated encryption against potential attacks and combining data in one basket may be inherently associated with a trustiness issue. Protecting privacy while maximally using available data has been an urgent problem in the era of big data. Concerns of data security and privacy have led to more stringent regulations on the use of data in machine learning. For instance, the European Union's General Data Protection Regulation (GDPR) requires data curators to use more plain language for privacy agreements, and to explain how the algorithms make a particular decision based on users' data. There is considerable interest in designing machine learning architectures that facilitate not only accuracy, but also privacy, data security, and fairness.

State-of-the-art technology ensuring privacy and fairness usually focuses on protecting users' data. However, there is also a growing demand for protecting the learner units who manage data. For example, consider that a health insurance company and a bank collect different features from a large group of people; the bank has information such as deposit, salary, and debt, while the health insurance has various medical records. If the health insurance company wants to develop a new insurance product with high return, it is beneficial for the health insurance company to know the financial statues of the targeted clients. Yet, the bank will not directly disclose any individual-level data even if they are perturbed. There exists an incentive to both parties that the bank provides services that do not directly transmit data but still provide relevant information for the insurance company to facilitate machine learning services.

A relevant concern for the bank is the possibility that its developed model is to be reconstructed if an adversary keeps querying. If such a reconstruction occurs, it can be even worse than data release from the bank's perspective, since its core advantage is often the learned black-box model rather than data itself. For example, in financial market, data can be accessed by many algorithmic traders, but the core advantage of a successful trader is a sophisticated algorithm being deployed. In the context of fairness, a user may decide to provide key statistics to assist others' learning while hiding sensitive features and other data.

In the following description, the present disclosure describes technology for a machine learning architecture having a configuration of agents operating as modules where each module may be a service module that provides assisting learning to or a user module that receives assisting learning from the other. Regarding assisted learning, the present disclosure may refer to improving a particular module's machine learning performance using information (e.g., statistics) from one or more other modules. As described herein, modules in the machine learning architecture implement a technique to ensure data and algorithm privacy (e.g., module privacy and other privacy concepts), enabling these modules to provide services and/or assisted learning without disclosing any proprietary information (e.g., models). Module privacy, as a concept, refers to protecting the privacy of an agent's proprietary model in addition to protecting the entity's data and may also be known as model privacy. The concept of relative module privacy highlights a privacy level when an adversary obtains side-information that can compromise the existent privacy, which includes module privacy and (possibly) other privacy concepts. Examples of the other privacy concepts include objective privacy and differential privacy of which one or both may be enabled by the present disclosure.

The non-patent literature entitled “ASCII: ASsisted Classification with Ignorance Interchange” by Zhou et al. and published via https://arxiv.org/abs/2010.10747 on Oct. 20, 2020 provides details for examples of the machine learning architecture described in the present disclosure and has been incorporated in its entirety. These details exemplify the technology enabling the systems and techniques described herein for improving an agent's machine learning (i.e., classification) performance through assistance from other agents. This improvement is facilitated (at least in part) by iteratively interchanging amongst two or more agents confidence scores (e.g., values between 0 and 1) for each collated sample where each confidence score represents the urgency of further assistance needed. The following also describes technology that is naturally suitable for privacy-aware, transmission-economical, and decentralized learning scenarios. Furthermore, the technology described herein may be categorized as generic for operating with any machine learning architecture, thereby allowing the agents to select any classifier; any given one of these agents may select an arbitrary classifier, such as logistic regression, ensemble tree, and neural network, and/or a classifier that may be heterogeneous amongst the other agents in the assisted learning protocol.

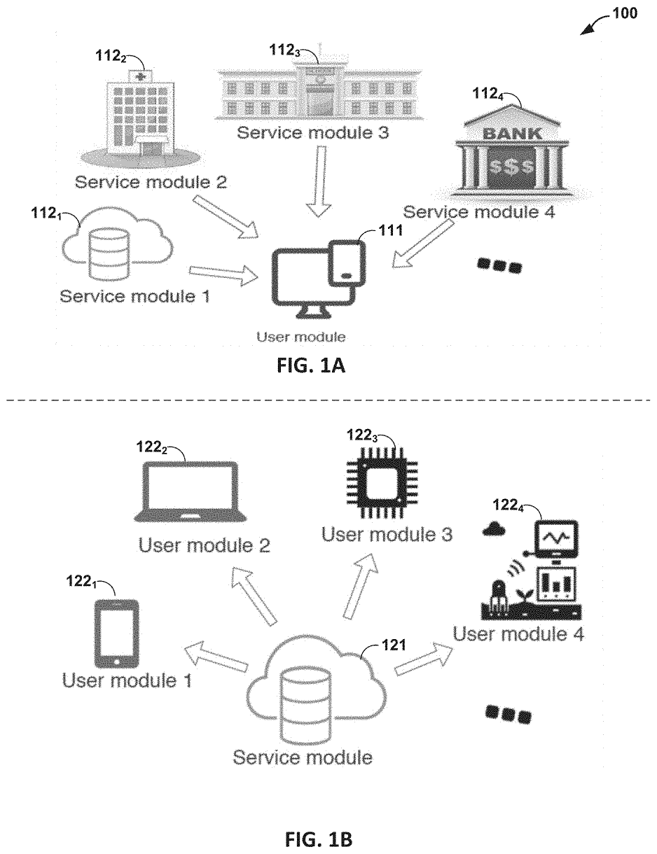

FIGS. 1A-B are block diagrams illustrating an example architecture 100 having two modes in which agents to exchange statistical information and build machine learning models, in accordance with one or more techniques of the disclosure.

An agent typically refers to any entity system in which one or more computing systems/networks provide services to an entity's infrastructure (e.g., employees, customers, and other users). An example entity may include a corporation, a non-profit or government organization, a foreign nation, and/or the like, and some of the services provided to the example entity's users include machine learning services via example architecture 100 as described herein. Each agent may be equipped with sufficient hardware/software to perform different operations on behalf of the entity that, in general, process and/or store data describing a number of users, for instance, by analyzing some aspect of those users' lives.

Example architecture 100 represents a (e.g., decentralized or centralized) network formed by multiple agents operating peer learner units or “modules”. In general, a learner unit or module represents one or more machine learning constructs, such as any of the machine learning model examples as described herein. In one example, an agent may operate in example architecture 100 as either a service module or a user module—depending upon which operating mode is in effect—and in accordance with an assisted learning protocol, engage in assisted learning (or another machine learning service) with at least one other agent in a same architecture 100. The agent may cooperate with the at least one other agent by executing logic configured to exchange statistical information that may be useful in building local prediction models for the agent's stored data. To facilitate the agent's operation(s), each agent has built one or more predictive models (e.g., machine learning models) to determine one or more estimated values (e.g., a quantitative and/or qualitative value) based on the user data analyzed thus far. There are a number of ways in which a local prediction model benefits that agent, such as by enabling certain functionality including those deemed prohibitive due to privacy concerns and confidentiality.

FIG. 1A depicts an example operating mode where one agent operates a user module 111 (“user module”) that receives assisted learning from agents operating service modules 112 (e.g., service module 112₁ represented as “service module 1”, service module 112₂ represented as “service module 2”, service module 112₃ represented as “service module 3”, and service module 112₄ represented as “service module 4”). Each module regardless of designation as a user module or a service module is a learner unit, and the present disclosure may describe module and learner unit interchangeably.

A module generally represents a collection of machine learning resources or constructs. The module may have access to disparate sources of user data and run logic to organize, into structured datasets, the decentralized user data. One example structured dataset, a task label set {X₁; y₁}, may be input (e.g., feature data) for a learner unit (A₁) configured to apply a learning technique and produce a (e.g., fitted) label set (denoted as A₁{X₁; y₁} or {X₁; \tilde{y}₁}). Examples of the learning technique include supervised or unsupervised learning algorithms, such as linear regression, Logistic Regression, Decision Tree, SVM, Naive Bayes, a decision ensemble, among others. The task label set {X₁; y₁} may include a set of observed labels that are either determined offline, provided by another learner unit on a remote device, determined via a machine learning model, or through another supervised learning algorithm. The labels represent the learning task of interest. The labels can be numerical responses in regression learning or numerically embedded class labels in classification learning. The learning technique applied by learner unit A₁ may create a function that processes, as input, the task label set {X₁; y₁} and computes, as output, an (e.g., expected) label set {X₁; \tilde{y}₁}. The learning technique applied by learner unit A₁ over a number of iterations may update (e.g., train) the function to generate an expected label set \tilde{y}₁ to more accurately predict an observed label set from the feature set (X₁). To illustrate by way of example, an example learner unit function for a linear regression algorithm may be in the form of \tilde{y}₁=mX₁+b due to an expected linear distribution of the observed labels. Over time, learner unit A₁ may calibrate the values for m and b and the expected label set \tilde{y}₁ to more accurately predict the observed label set.

Example architecture 100 may be a machine learning architecture that, over time, trains local models for each agent. In one example, learner unit A₁ may generate a machine learning model that maps a feature set {X₁} of a data corpus to an observed task label (y₁) denoting a particular value (e.g., regression) or classification. The model may be linear or non-linear in distribution. The model may be parameterized or non-parameterized. Learner unit A₁ may generate a deterministic function that maps another observed label set (X₂; y₂) in the data corpus to a second label set using the learner unit A₁. The other (second) label set (X₂;y₂) results from another learner unit A₂ from another agent operating as a module (e.g., a service module). As described herein for assisted learning in a machine learning architecture, learner unit A1 may advantageously use the second label set for intelligence to be used in training the machine learning model.

The module, operating as either a user module or a service module as described herein, may desire assisted learning from another module in example architecture 100. The module may employ a number of techniques to select a proper module to exchange information. The following example technique can be used for a module to autonomously find one or more other modules to engage with for assisted learning: Before a module (Module 0) initializes an assisted learning with any other module (Module 1). Module 0 solicits from Module 1 a certain statistic calculated using Module 1's local data and based on that statistic, determines whether Module 1 is able to provide assistance. An example of such statistic is a linear combination of Module 1's feature variables, where the linear coefficients are randomly generated by Module 1 to properly privatize its locally held data. Upon receipt of the linearly combined variable, Module 0 will evaluate the statistical association between such a variable and its learning labels or fitted residuals calculated from its local data. Module 0 may use the calculated association to determine whether Module 1 has the potential to provide assistance.

As an alternative, the module may utilize a different technique to autonomously find one or more modules to engage with for assisted learning and that technique may be executed when the module employs a non-parametric machine learning model. If two (or more) modules are from a same data generating distribution (e.g., a centralized datasets of input features), then one module's learning unit and machine learning model should perform similarly when applied to another module's dataset. The module may use a certain statistic, such as a measurement of such similarity, to determine whether the module can be grouped with the other module of similar nature, and then, repeat a same determination for each other module. The module may identify one or more modules based on the certain statistics and further initialize an assisted learning procedure with either one other module or multiple other modules.

Regarding the above method, the module's learning unit and machine learning model include regression functions configured to, based on validation data, determine a (maximum) number of rounds of assistance in the assisted learning procedure with the other module. The validation data may be determined by cross validation within the other module(s).

In one example depicted in FIG. 1A, user module 111 may be a health insurance company that receives assisted learning from agents operating as service modules 112. As illustrated, the health insurance company, as user module 111, may receive assisted learning from service modules 112 including a generic service module, a hospital, a school, and a bank, respectively. The generic service module represents another possible agent including another health insurance company. When the health insurance company requests assisted learning from the generic service module, the hospital, the school, and/or the bank, the health insurance company in response, receives statistical information to improve upon accuracy of the (observed) labeled dataset {X₁; y₁} and the learner unit A₁.

The health insurance company, the generic service module, the hospital, the school, and/or the bank collect various information for different feature sets from a substantial number of people. The bank may store attributes for features, such as deposit, salary, debt, and/or the like while the health insurance company stores feature attributes in various types of medical records. If the health insurance company wants to develop a new insurance product with high return, it is beneficial to know the financial status of each targeted client. Yet, the bank will not directly disclosure any individual-level data even if they are perturbed. There exists an incentive to both parties that the bank provides services that do not directly transmit data but still provide relevant information for the health insurance company to facilitate its own learning.

To provide an enhanced level or privacy, the health insurance company receives certain statistical information with the generic service module, the hospital, the school, and/or the bank. By exchanging the certain statistical information, the generic service module, the hospital, the school, and/or the bank may retain sensitive data in secure data stores. Hence, the bank in the above-mentioned example does not disclose any individual-level data such as a financial status to the health insurance company. The bank also does not expose their proprietary learner unit A_{bank} including any information associated with their proprietary learner unit A_{bank}. This may include the bank's proprietary feature set (X_{bank}), an initial mapping between (X_{bank}) and (observed) label set (y_{bank}), a proprietary model used in predicting observed label set (y_{bank}) by mapping the feature set (X_{bank}) to label set (\tilde{y}_{bank}), and a learning technique to fit the label set (y_{bank}) to a fitted label set (\tilde{y}_{bank}) by calibrating the model over a number of iterations.

Therefore, by implementing the techniques described herein, the health insurance company, operating as the user module 111 in FIG. 1A, may use the certain statistical information to improve upon the company's propriety learner unit A_{Insurance} while neither disclosing any proprietary information (e.g., an observed label set) nor receiving any feature information or model information from any of the service modules 112 in FIG. 1B. Once the learner unit A_{Insurance} is sufficiently trained, the health insurance company may use the learner unit A_{Insurance}, to make predictions regarding existing users and new users. In one example, the health insurance company may query service modules 112 for set of predictions on a same user and by combining (e.g., aggregating) the set of predictions with a local prediction regarding the same user, produce a predicted label for that same user.

The nature of the certain statistical information may depend upon which learning technique is employed by an agent, such as the health insurance company when operating as user module 111. User module 111 may be configured with a corresponding model for any learning technique (e.g., linear regression) and, by way of assisted learning, receive statistics related to a compatible model in one or more service modules 112. User module 111 may employ a number of statistical methods to update the corresponding model with the received statistics. In one example, if the health insurance company is creating a learner unit using any example learning technique and a corresponding model, appropriate statistical information may include ignorance scores or confidence values, such as one or more weights from fitting, into a label set, an observed label set when the fitted label set and, possibly, the observed label set are based upon a feature set. It should be noted that the present disclosure describes the operation of fitting, into the label set, the observed label set as functionality equivalent to fitting, into the observed label set, the label set. The example learning technique may update the learner unit (e.g., the corresponding model) to better approximate the fitted label set from the same feature set.

FIG. 1B introduces a different perspective into example architecture 100 from FIG. 1A: An agent, operating a service module 121, engages in assisted learning with, e.g., four agents that operate user modules 122. In general, user modules 122₁ . . . 122₃ (collectively referred to as “user modules 122”) and (generic) user module 122₄ form an assisted learning framework for example architecture 100 where multiple organizations with discordant learning goals/objectives and heterogeneous/multimodal data whose sharing is prohibited exchange statistical information for mutual benefit as described herein.

In some examples, service module 121 and each of user modules 122 limit their data exchanges to task-relevant statistics instead of raw data. In one example, service module 121 (e.g., a clinic research laboratory) provides other agents, including the four agents that operate user modules 122, with various services (e.g., clinical research services) without sharing sensitive data (e.g., patient data) and may employ artificial intelligence (e.g., machine learning models) in these services. To provide the four agents that operate user modules 122 with assisted learning, service module 121 may share statistical information corresponding to a machine learning model.

As described herein, the statistical information being shared between two or more agents (e.g., service module 121 and user modules 122) may include numerical values (e.g., ignorance scores) indicative of a state of an agent's proprietary local model; furthermore, by “state”, the present disclosure envisions an accuracy metric regarding the local model's current ability to generate an expected label distribution that predicts the observed label distribution. As an example, example architecture 100 may enable confidence values regarding the proprietary model's possible deployment in a live environment including the model's reliability to estimate accurate labels for new feature sets. Depending on which learning technique the above-mentioned agent implements for training its proprietary local model, a number of known methods (including variations) may compute the confidence values, and the present disclosure envisions these values manifesting in a variety of ways (e.g., random variables in multi-variate equations, parameters of specific algorithms, constants, mathematical expressions, and/or the like) throughout any example training process.

The following describes an assisted learning protocol for agents of example architecture 100 and in some examples of that protocol, these agents execute a training process to build proprietary models to generate an accurate mapping from proprietary and/or private feature sets to expected label sets. The assisted learning protocol may define, for the agent's local models, example confidence values as weights (e.g., learned) from fitting the expected label set into an observed label set. One agent, in accordance with assisted learning protocol, may exchange one or more weights with at least one other agent and to leverage intelligence from the at least one other agent's confidence values, the first agent may incorporate each agent's weight into generate an updated expected label set.

In one example, user module 122₁ (e.g., a computing device in a hospital) and service module 121 (e.g., a clinic research laboratory) both store feature sets from a same group of people and use those features in separate models. Both service module 121 and user module 122₁ use their respective models to predict a random hospital patient's Length of Stay (LOS), which is one of the most important driving forces of hospital costs. While user module 122₁ trains its proprietary model, service module 121 provides statistical information that user module 122₁ utilizes to advance the proprietary model's training.

In a multi-agent example, another user module, user module 122₂ (e.g., a computing device in a health insurance company) may also receive assisted learning in the form of statistical information from service module 121. Because user module 122₂ builds its own proprietary model, that model's parameters and feature sets most likely differ from the corresponding model parameters and feature sets used in the service module 121 and user module 122₁. Furthermore, service module 121 may provide user module 122₂ with different statistical information. To illustrate an instance where the example architecture 100 enables objective privacy (e.g., via the exchange of confidence values), user module 122₂, in some examples, trains the proprietary model with a different objective than the models of the service module 121 and user module 122₁, such as a prediction other than the random patient's LOS. Even if user module 122₂ trains the proprietary model with the same objective of predicting the random patient's LOS, the model's prediction may be different from the model of user module 122₁.

In any of the above examples, user module 122₁ and/or user module 122₂ may send their own respective task-related statistics to service module 121 and in turn, receive service module 121's task-related statistical response based on each user module's respective task-related statistics. Each module generates task-related statistics that do not expose any of that module's (e.g., proprietary) feature data (e.g., patient data) nor label data (e.g., model prediction data). In this manner, each module maintains the privacy of their confidential data (e.g., differential privacy) as well as their proprietary model (e.g., module privacy). In some instances, a given module maintains objective privacy as well by not transmitting any data indicating the given module's proprietary model's prediction.

In general, service module 121 may build, train, and then, deploy a machine learning model having a supervise relation (e.g., a mapping) between a specific set of input features (e.g., a feature set X) and an output prediction (e.g., a label set Y). In another example, service module 121 and one or more user modules 122 may build models configured to predict a certain health index for the random patient. Service module 121 may create a learner unit A to train a supervise function ƒ to fit the random patient's health index such that the function ƒ may better predict for that patient a revised health index given a different set of features. With respect to user module 122₁ (e.g., a doctor's computing device in a hospital) which provides services (e.g., health services of which some employ artificial intelligence such as machine learning models) regarding the above patient, these services may rely upon an accurate machine learning model for a representative learner unit, learner unit A₁.

In one example, service module 121 determines parameters (e.g., weights) for the mathematical function ƒ that processes, as input, the feature set X and generates, as output, the label set Y. The label set Y may be a fitted label set such that each fitted label is an expected outcome (e.g., expected health index) in accordance with a distribution of the mathematical function ƒ. During training, a set of weights from fitting, into the fitted label set, an observed label set (e.g., observed health indexes) are used to update the function ƒ to more accurately predict the expected outcome.

The set of weights, which may be known as sample weights, can be used as confidence scores but is not limited to any statistical information. Service module 121 may seek assistance from one or more user modules by exchanging these confidence scores over a number of iterations. An iteration may be one round of exchange, for example, where service module 121 sends confidence scores for a local model being trained by a user module and in response, receives from that user module confidence scores for the above machine learning model. For the other user module (e.g., user module 122₁), service module 121 determines a second set of weights (i.e., confidence scores) between a second set of fitted labels and the set of weights (as the observed label set) for updating the function fin the machine learning model for the learner unit A.

To illustrate, the hospital operating as user module 122₁ may include a learner unit A₂ and a machine learning model relating another feature set (X₂) with the certain health index to produce the second fitted label set (Y₂). User module 122₁ may use the confidence scores from the service module 121 as the second set of weights between the second fitted label set (Y₂) and the set of weights from the service module 121. User module 122₁ may also use the confidence scores from the service module 122 to update the (first) set of weights to operate, for a next iteration of assisted learning, as confidence scores for the machine learning model being trained by service module 121.

A different hospital operating as user module 122₂ may include a learner unit A₃ and a machine learning model relating another feature set (X₃) with the health index to produce yet another fitted label set (Y₃). The service module 121 may use another set of weights between label set Y₃ and the set of results to update the mathematical function ƒ for learner unit A₁. Each user module includes a feature set that contains different (or partially overlapping) features that correspond to the same group of patients.

It should be noted that the above-mentioned health index differs from a matrix index or column vectors index. Each module maintains input feature sets in a matrix or as column vectors where each column is a feature vector for all patients and each row is a single patient's feature set. Two or more agents have collated matrices/column vectors if their rows are aligned with a common index, such as a timestamp, a username, or a unique identifier.

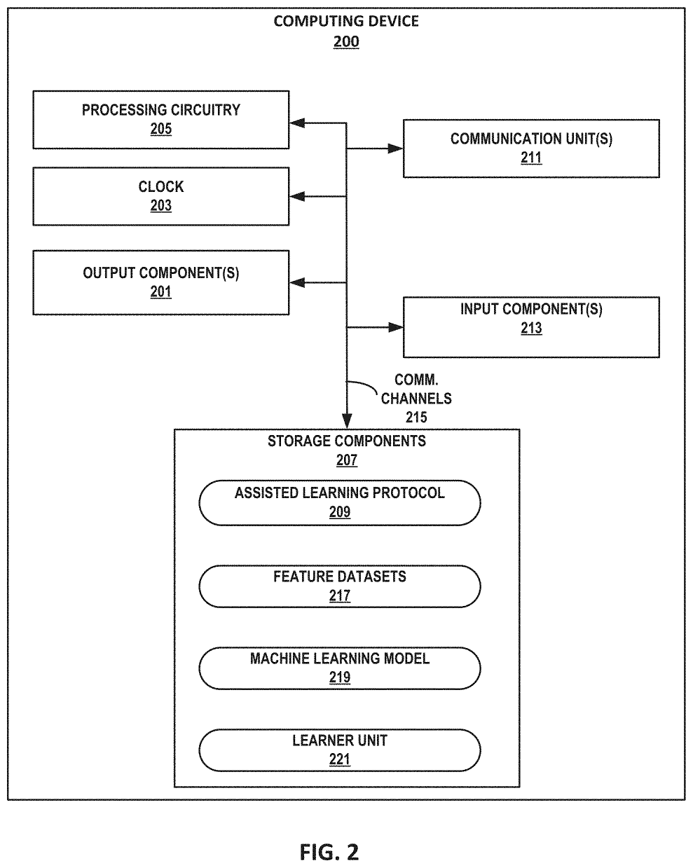

FIG. 2 is a block diagram illustrating example computing device 200 within an agent for example architecture 100 of FIG. 1A and/or 1B, in accordance with one or more techniques of the disclosure. Computing device 200 of FIG. 2 is described below as an example computing device being used by an agent while operating as either a user module or a service module of FIG. 1A and/or 1B. FIG. 2 illustrates only one example of computing device 200, and many other examples of computing device 200 may be used in other instances and may include a subset of the components included in example computing device 200 or may include additional components not shown in example computing device 200 of FIG. 2.

As shown in the example of FIG. 2, computing device 200 includes one or more output components 201, clock 203, processing circuitry 205, one or more storage components 207, one or more communication units 211, and one or more input components 213. Communication channels 215 may interconnect each of the components 201, 203, 205, 207, 211, and 213 for inter-component communications (physically, communicatively, and/or operatively). In some examples, communication channels 215 may include a system bus, a network connection, an inter-process communication data structure, or any other method for communicating data.

One or more communication units 211 of computing device 200 may communicate with external devices, such another of computing devices 102 of FIG. 1A and/or FIG. 1B, via one or more wired and/or wireless networks by transmitting and/or receiving network signals on the one or more networks. Examples of communication units 211 include a network interface card (e.g., such as an Ethernet card), an optical transceiver, a radio frequency transceiver, a GPS receiver, or any other type of device that can send and/or receive information. Other examples of communication units 211 may include short wave radios, cellular data radios, wireless network radios, as well as universal serial bus (USB) controllers.

One or more input components 213 of computing device 200 may receive input. Examples of input are tactile, audio, and video input. Input components 213 of computing device 200, in one example, includes a presence-sensitive input device (e.g., a touch sensitive screen, a PSD), mouse, keyboard, voice responsive system, video camera, microphone or any other type of device for detecting input from a human or machine. In some examples, input components 213 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., microphone, camera, infrared proximity sensor, hygrometer, and the like).

One or more output components 201 of computing device 200 may generate output. Examples of output are tactile, audio, and video output. Output components 201 of computing device 200, in one example, includes a PSD, sound card, video graphics adapter card, speaker, cathode ray tube (CRT) monitor, liquid crystal display (LCD), or any other type of device for generating output to a human or machine.

Clock 203 is a device that allows computing device 200 to measure the passage of time (e.g., track system time). Clock 203 typically operates at a set frequency and measures a number of ticks that have transpired since some arbitrary starting date. Clock 203 may be implemented in hardware or software.

Processing circuitry 205 may implement functionality and/or execute instructions associated with computing device 200. Examples of processing circuitry 205 include application processors, display controllers, auxiliary processors, one or more sensor hubs, and any other hardware configure to function as a processor, a processing unit, or a processing device. Assisted learning protocol 209 may be operable by processing circuitry 205 to perform various actions, operations, or functions of computing device 200. For example, processing circuitry 205 of computing device 200 may retrieve and execute instructions stored by storage components 207 that cause processing circuitry 205 to perform the operations of assisted learning protocol 209. The instructions, when executed by processing circuitry 205, may cause computing device 200 to store information within storage components 207.

One or more storage components 207 within computing device 200 may store information for processing during operation of computing device 200 (e.g., computing device 200 may store data accessed by assisted learning protocol 209 during execution at computing device 200). In some examples, storage component 207 includes a temporary memory, meaning that a primary purpose of one example of storage components 207 is not long-term storage. Storage components 207 on computing device 200 may be configured for short-term storage of information as volatile memory and therefore not retain stored contents if powered off. Examples of volatile memories include random-access memories (RAM), dynamic random-access memories (DRAM), static random-access memories (SRAM), and other forms of volatile memories known in the art.

Storage components 207, in some examples, also include one or more computer-readable storage media. Storage components 207 in some examples include one or more non-transitory computer-readable storage mediums. Storage components 207 may be configured to store larger amounts of information than typically stored by volatile memory. Storage components 207 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 207 may store program instructions and/or information (e.g., data) associated with assisted learning protocol 209. Storage components 207 may include a memory configured to store data or other information associated with assisted learning protocol 209.

Assisted learning protocol 209 connects to example architecture 100 learner unit 221 to operate as a service module, a user module, or both user module and service module. As a service module, assisted learning protocol 209 provides user modules with a service (e.g., an artificial intelligence service); as a user module, assisted learning protocol 209 requests services from service modules. The agent, as described herein, may maintain a number of computing devices, such as computing device 200, for use in creating, training, and deploying machine learning constructs (e.g., models). The agent may provide these computing devices to example architecture 100 to run as a module (e.g., user module, service module, or both user module and service module). In each computing device, assisted learning protocol 209 may direct that computing device's performance of operations and in some examples, may utilize learner unit 221 for machine learning services. As described herein, learner unit 221 generally represents a collection of machine learning resources in which at least one model is configured to predict data useful to the agent, for example, in performing some task or achieving an objective.

In either capacity, an example computing device exchanges with other computing devices statistical information to improve upon a modeling of user data. In some examples, assisted learning protocol 209 distributes to one or more computing devices in example architecture 100 statistical information for improving each computing device's learner unit and any machine learning model used by that learner unit. Assisted learning protocol 209 may perform such distribution in response to receiving statistical information from another computing device. Assisted learning protocol 209 may use the received statistical information to improve learner unit 221 and any machine learning model 219 used by learner unit 221.

One operation of assisted learning protocol 209 is to improve a learning quality of at least learner unit 221, by allowing computing device 200, operating as a module, to exchange statistics with other computing devices operating as modules. In one example, for computing device 200 to receive assistance from other modules in example architecture 100, feature datasets 217 and respective feature datasets from the other modules are to be aligned or partially aligned (e.g., collated). Two datasets D1 and D2 are aligned datasets if the two datasets can be aligned by some common feature (referred to as index). For example, the common index can be a date. Having aligned or partially aligned feature datasets, assisted learning protocol 209 may further improve upon a learning quality of learner unit 221.

Learner unit 221, as a component of computing device 200, may represent logic implementing computational functionality or processor-executable instructions. Via assisted learning protocol 209, computing device 200 trains machine learning model 219 for use by learner unit 221, for example, in generating predictions. In one example, machine learning model 219 may include a linear distribution relating a feature set X to a label Y and learner unit 221 may fit label Y along the same linear distribution and produce a fitted label \tilde{Y}. In another example, while machine learning model 219 may include a non-linear distribution relating a feature set X to a label Y, learner unit 221 may include a function to fit label Y along a linear distribution and produce a fitted label \tilde{Y}. The function in learner unit 221 may approximate the label Y more efficiently than machine learning model 219.

Learner unit 221 may be executed on processing circuitry 205 and operate as an agent in the example architecture. In a two-agent scenario for the example architecture, learner unit 221 may execute a training process on machine learning model 219 by exchanging, with at least one other agent of the assisted learning architecture, iterations of confidence scores where the at least one other agent is configured to train at least one other machine learning model. For each iteration, learner unit 221 determines a set of sample weights as the confidence scores for machine learning model 219 and then, communicates, to a second agent of the at least one agent, a second set of sample weights as the confidence scores for a second machine learning model of the at least one other machine learning model. The confidence scores for machine learning model 219 corresponds to a progress level in the training process and the confidence scores for the second machine learning model correspond to a progress level in training the second machine learning model when compared to the progress level in training the machine learning model. In turn, the second agent updates the set of sample weights in response to further training the second machine learning model and then, returns to learner unit 221 a next iteration of the confidence scores for training machine learning model 219. The updated set of sample weights and a model weight for learner unit 221 may be determined from the confidence scores of the second machine learning model.

One example learning technique to improve the machine learning capabilities of computing device 200 directs assisted learning protocol 209 to create, by processing circuitry 205, learner unit 221 by fitting an initial label set with a task label set to generate a fitted first label set for machine learning model 219.

In one example, learner unit 221 may proceed to generate a model weight for fitting, into the task label set, a dataset combining the first feature set and the first label set. The first learning technique may direct learner unit 221 to train machine learning model 219 to map a first feature set to the first label set based on confidence scores for samples in the first feature set. Based on the first label set, the model weight, and the first confidence scores, the example technique directs learner unit 221 to compute, by processing circuitry 205, second confidence scores as first statistical information, which is communicated to a second agent for use in fitting (e.g., updating) their local model. The second confidence scores correspond to samples in that local model and may be computed from the model weight and the confidence scores for the samples in the first feature set.

Learner unit 221 obtains and provides assistance to one or more agents by exchanging confidence scores using assisted learning protocol 209. In some examples, via assisted learning protocol 209, learner unit 221 sends, to a second learner unit of a second computing device for the second agent, the second confidence scores for samples in a second feature set used by the second learner unit in training a second machine learning model with the task label set using a second learning technique. The second learner unit for the second agent, in accordance with the second learning technique, generates a second model weight for fitting, into the task label set, a dataset combining the second feature set, a second label set, and the second confidence scores.

In some examples, after the second agent fits their local model to a weighted observed label set and generated an updated local model, the second agent returns, to computing device 200, updated first confidence scores corresponding to a model confidence (or an objective confidence) in machine learning model 219 and the second model weight from fitting their local model. Learner unit 221 receives, from the second learner unit of the second computing device, the second model weight and a next iteration of the confidence scores defined by the second model weight and the second label set.

The example learning technique directs learner unit 221 to update machine learning model 219 based on the second confidence scores, which may cause the generation of a second, updated version of machine learning model 219. According to the first learning technique, learner unit 221 trains machine learning model 219 such that the trained model is configured to map the first feature set to a third label set based on the next iteration of the confidence scores and the second model weight. The third label set represents a better fit set of labels when compared to the task label set. Assisted learning protocol 209 may proceed to determine the first model weight from minimizing a loss function from fitting a weighted label set from machine learning model 219 with the observed label set into the updated version of machine learning model 219. Based on the updated first model weight, assisted learning protocol 209 may prompt learner unit 221 to update the second confidence scores and communicate the updated second confidence scores to the second agent. The second agent may conclude the iteration by updating at least a portion of the first confidence scores and returning both the updated model weight and the updated first confidence score to computing device 200.

Alternatively, the second agent may communicate, to a third agent, third confidence scores for the third agent's local model where the third confidence scores are based on the second model weight and correspond to a model confidence and an object confidence in the third agent's local model. In a multi-agent scenario, the third agent is a next agent to provide assistance after the second agent and therefore, receives the third confidence score. In some examples, the third confidence scores are derived from the first confidence scores. If the third agent is a last agent, the third agent returns, to computing device 200, a fourth confidence score indicative of the third agent's model confidence in machine learning model 219. If the third agent is not the last agent, the third agent communicates fifth confidence scores to a fourth agent where the fifth confidence scores correspond to a model confidence and objective confidence in the fourth agent's local model. Similar to the third confidence scores, the fifth confidence scores are derived from the first confidence scores.

In one particular example, computing device 200 represents a hospital device configured with a set of labeled data (X₀, Y₀) and supervised learning algorithms for performing machine learning services for hospital patients and/or personnel. The hospital may be an organization with m divisions (e.g., Intensive Care Unit, In-hospital laboratory, out-patient laboratory, and/or the like), and for the hospital, computing device 200 directs assisted learning protocol 209 when those divisions are performing different learning tasks/goals with distinct labeled data (Xᵢ, Yᵢ) where i=1, 2 . . . , m and (proprietary) local models where (Xᵢ) for i=1, 2, . . . , m can be collated. The hospital desires assistance from others to facilitate training for its model while retaining its sensitive data and for potential rewards, may assist others in the training of their model with their own learning algorithm. Because the m divisions share a substantial portion of the same sensitive data, the m divisions may run off centralized datasets. However, if there is a substantial risk to sharing any sensitive data between them, the partially aligned or aligned data sets are on remote devices. An example learning algorithm may represent a linear regression, a decision ensemble, a neural network, or a set of models from which a suitable one is chosen using model selection techniques. For example, when the least squares method is used to learn the supervised relation between X and y, then a prediction function is a linear operator for a predictor feature.

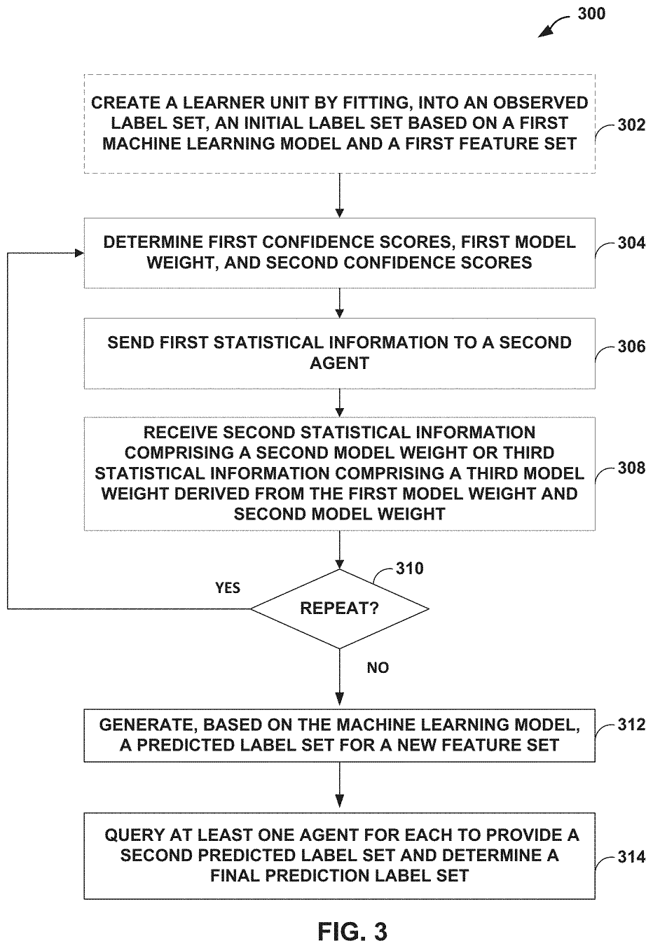

FIG. 3 is a flowchart illustrating an example process 300 of an example architecture 100 of FIG. 1A and/or FIG. 1B, in accordance with one or more techniques of the disclosure. For purposes of illustration only, FIG. 3 is described with respect to FIG. 2.

Example process 300 may be codified in assisted learning protocol 209 as a technique for confidence-based assistance learning, for example, a two-stage process combining a training process and an evaluation process for a machine learning model. Techniques for confidence-based assisted learning in two-agent scenarios (Section 3) and multi-agent scenarios (Section 4) can be found in non-patent literature entitled “Assisted Learning: A Framework for Multi-Organization Learning” by Xian et al. and published via https://arxiv.org/abs/2004.00566 on Apr. 1, 2020, which has been incorporated in its entirety.

Processing circuitry 205, via assisted learning protocol 209, may introduce the learner unit into the training process and/or the evaluation process as a more efficient machine learning construct (e.g., and solution for predicting observed labels) than machine learning model 219. Assisted learning protocol 209 may define the learner unit as a configurable option, for example, if machine learning model 219 can be further approximated (e.g., modeled) or, otherwise, simplified. Assisted learning protocol 209, as an alternative, may allow processing circuitry 205, to rely on machine learning model 219 for predicting observed labels without creating learner unit. Accordingly, the learner unit may represent one example variation of example process 300, or a portion thereof.

The present disclosure envisions a number of possible variations to the training process and/or the evaluation process and, as described herein, one or more variations may be implemented by assisted learning protocol 209 as configurable options. Examples of some variants include a training process or an evaluation process where: 1) multiple agents provided assisted learning as opposed to one agent; 2) instead of a fixed ordering, an optimal ordering of agents is determined; 3) a dynamic and/or robust stopping criterion is used to limit the number of iterations instead of having the first agent pre-determine the number of iterations; 4) a different solution to the minimization problem is implement; 5) an alternative fitting mechanism for computing model weights for fitting a label set with another label set to generate a fitted label set. A number of factors may further affect the training process and/or the evaluation process. The present disclosure envisions a number of additional ways for directing execution of the training process and/or the evaluation process in accordance with assisted learning protocol 209.

As one example, having an ineffective minimization solution may substantially impact performance. There are a number of example loss functions of which each is capable of solving the minimization problem (e.g., in terms of empirical risk and reward) including the negative log-likelihood loss, cross-entropy loss and Hyvarinen loss functions. In some examples, each agent may solve the minimization problem by (e.g., privately) specifying an appropriate minimization loss function to use.

In computing device 200 operating as a module in example architecture 100, processing circuitry 205 creates learner unit 221 for a first agent by fitting, into a first label set, an initial label set based on a machine learning model and a first feature set (302). The first machine learning model may be configured to map the first feature set to a first label set, and the learner unit executes a learning technique configured to train the first machine learning model to predict an observed label set. As described herein, the machine learning model may be configured with a function for mapping samples of the first feature set to a label space of output classes. Processing circuitry 205 may access each feature vector of the first feature set and invoke the machine learning model to predict a corresponding a label of the initial label set. Having the initial label set, processing circuitry 205 may configure the learner unit with a learning technique to generate the first label set to include the fitted label set. In one example of the learning technique, processing circuitry 205 may invoke learner unit to fit the initial label set to an observed label set such that the resulting fitted first label set more accurately approximates the observed label set than the initial label set.

For an example training process, processing circuitry 205 may implement a minimization solution (e.g., sums of squared error (SSE) or maximum likelihood) for accurately fitting the initial label set with the observed label set and then, iteratively, fitting the observed label set into an updated label set. The minimization solution may include a loss function to determine a prediction loss (e.g., an error or an in-sample loss). In one example, the minimization solution may include at least one method to minimize the in-sample loss for machine learning model 219 for example, with a weighted average between the observed label set and an expected label set (e.g., fitted label set) based on machine learning model 219. In another example, a weighted observed label set or a weighted expected label set may be used to minimize the in-sample loss. In both examples, the minimization solution may define information including one or more model weights for computing any of the above weighted labels. Processing circuitry 205 may determine values to set for the one or more model weights such that the in-sample loss is minimized or substantially minimized.

In some examples, processing circuitry 205 may execute a learning technique in accordance with machine learning model 219 by processing, as input, the first feature set and producing, as output, a set of expected labels that, together, form a label set such as an initial label set for learner unit 221. In some examples, machine learning model 219 codifies (e.g., into each function) a relationship (e.g., a mapping) between one or more feature attributes of each user in the first feature set and an expected label predicting some knowledge or intelligence (e.g., an observed label). Processing circuitry 205 may further execute the learning technique in accordance with learner unit 221 to fit the initial label set into a (fitted) label set in accordance with a loss minimization solution and the observed label set.

In some examples, using machine learning model 219, processing circuitry 205 creates learner unit 221 by determining a function ‘ƒ’ configured to fit the initial label set into a first label set. Following the first learning technique, learner unit 221 may, over a number of iterations, continue to fit the function ‘ƒ’ by tuning terms (e.g., parameters or hyper-parameters) of the function ‘ƒ’ until that function generates (e.g., maps to) a fitted label set closely approximating the observed label set. In some examples, learner unit 221 generates the function ‘ƒ’ to have a linear relationship between the first feature set and the observed label set whereas machine learning model 219 generates a non-linear mapping between the first feature set and the observed label set. As described herein, learner unit 221 may codify function ‘ƒ’ with another relationship such as a non-linear relation, for example, where function ‘ƒ’ is configured to generate a quadratic distribution of expected labels (e.g., predictions).

To illustrate by way of example, in a linear regression learning technique as the first learning technique, function ‘ƒ’ follows a linear distribution. Each fitted label may be considered an expected data point and each initial label may be considered an observed data point such that a set of residuals between expected and observed data points can be used to update (e.g., fit) the function ‘ƒ’ in learner unit 221. In some examples, parameters (e.g., weights, constants, etc.) of function ‘ƒ’ may be adjusted (e.g., tuned) to fit the linear distribution to the observed label set (or, alternatively, the initial label set e.g., if the observed label set is not available).

In some examples, the function ‘ƒ’ in learner unit 221 includes one or more model weights that may be used in the example process 300 as statistical information to be exchanged with one or more agents in accordance with assisted learning protocol 209. A framework for assisted learning protocol 209 (e.g., example architecture 100 of FIG. 1A or 1B or another machine learning architecture) may include a plurality of agents operating as user or service modules; nonetheless, for a number of reasons, the example process 300 may limit assisted learning protocol 209 to ‘m’ modules for exchanging statistical information. In one example, based on communication bandwidth, cost constraints, and/or computational overhead, assisted learning protocol 209 may only select a subset of ‘m’ modules to exchange statistical information.

Processing circuitry 205 determines first confidence scores, a first model weight, and second confidence scores in accordance with the assisted learning protocol (304). The first confidence scores include a first set of sample weights from training a first machine learning model (e.g., by fitting the first label set). Machine learning model 219 may represent the first machine learning model. Processing circuitry 205 determines, from the first set of sample weights, the first model weight for fitting the first label set with the observed label set based on the first learning technique and the first machine learning model. Processing circuitry 205 then determines a second set of sample weights based on the first set of sample weights and the first model weight. The second set of sample weights correspond to training another machine learning model and therefore, may constitute second confidence scores for assisting another agent in training the other machine learning model.

In some examples, the second set of sample weights are defined by the first model weight for fitting, into the observed label set, the first label set based on the first learning technique, the first machine learning model, and the first feature set. Examples of the first model weight may be determined using any conceivable minimization function, such as one configured to minimize a predictive loss where that loss metric value is determined based on a weighted average of the observed labels and the expected (e.g., fitted) labels based on machine learning model 219 and/or learner unit 221. As described herein, processing circuitry 205 determines the first model weight(s) to minimize an in-sample prediction loss associated with the first machine learning model and after each iteration, updates the first model weight(s) to further minimize the in-sample prediction loss.

Processing circuitry 205 sends, to a second computing device of a second agent operating as a module in example architecture 100, first statistical information comprising the above second confidence scores (306). In general, a second machine learning model may be configured to map a second feature set to a second label set and the second agent may train the second machine learning model to predict the observed label set from the same feature set.

Processing circuitry 205 may send the first statistical information to a remote computing system of a decentralized network architecture or to another computing system of a centralized network architecture. The second agent of the second computing device, in turn, uses the second model weight in fitting a second label set into a second observed label set. The second agent may be configured to determine reward values and a second model weight from fitting, into the observed label set, the second label set based on a second learning technique and the first statistical information. The second computing device may employ a learner unit to determine, from the second set of labels, the second fitted label set using the second learning technique.

Processing circuitry 205 receives the second statistical information comprising the second model weight or third statistical information comprising a third model weight (308). The second computing device may return to the computing device the second statistical information comprising updated first statistical information and the second model weight after updating the second model based on the first statistical information. The second statistical information may further comprise the updated first set of sample weights.

From a third agent of the architecture, processing circuitry 205 receives third statistical information comprising the third model weight and a next iteration of the first set of sample weights as an alternative to the second statistical information. The third agent may derive the third model weight from the second statistical information and/or the first statistical information. In some examples, the third agent uses the second confidence scores, which are based on the first confidence scores, to derive the third model.

As described herein, the architecture may include multiple agents participating in example process 300, and the third agent may be a last agent to receive statistical information (e.g., confidence values); however, in a two-agent example architecture, the above-mentioned second agent receives, updates, and returns statistical information (e.g., weight vectors) to the first agent. As further described herein, the one or more third model weighs, similar to the first model weight(s) and second model weight(s), result from fitting a third label set with the observed label set based on the third machine learning model.

A third computing device operating as a third agent may communicate, to the computing device, the third statistical information and, in some examples, the third statistical information may include the third model weight(s) after updating a third machine learning model based on statistical information from a previous agent in the architecture. Given that each agent updates the statistical information provided by the previous agent, the third agent receives the statistical information derived from the second statistical information and/or the first statistical information. The third computing device agent may update the statistical information from the previous agent and communicate to the first agent the updated statistical information as part of the third statistical information.

Processing circuitry 205 may update machine learning model 219 using the first learning technique and the second statistical information or the third statistical information. In some examples, processing circuitry 205 updates the machine learning model to produce an updated machine learning model configured to map the first feature set to an updated first label set based on the updated first set of sample weights from the second agent or the next iteration of the first set of sample weights from the third agent. As a result, the updated machine learning model is configured to map the first feature set to an updated first label set based on the first statistical information and the second statistical information.

Processing circuitry 205 updates machine learning model 219 and/or learner unit 221 using the first learning technique and the second statistical information or the third statistical information to generate updated machine learning model 219. In some examples, processing circuitry 205 updates the first model weight based on the second statistical information or the third statistical information and then, generates updated machine learning model 219 to be configured to map the first feature set to an updated first label set further minimizing the prediction loss. Based on updated machine learning model 219, processing circuitry 205 may produce the updated label set based upon the updated first model weight and the first feature set, rendering the updated label set to be more fit (e.g., accurate with respect to the observed label set) than the first label set. In some examples, updating machine learning model 219 and/or learner unit 221 prompts an update to the function ‘ƒ’ as described herein.

Processing circuitry 205 repeats the steps of sending of statistical information, receiving of the second statistical information, and updating of the learner unit 221 (e.g., a training stage) for a number of iterations (310). If, based on the first learning technique, processing circuitry 205 determines that another round of assisted learning most likely will improve machine learning model 219 and/or learner unit 221 (YES of 310), in some examples, processing circuitry 205 sends, to the second agent or a fourth agent in the architecture, fourth statistical information defined by the updated first model weight(s) from fitting the updated first label set with the observed label set.

The fourth agent is different from the second agent and is selected for assistance based on a variety of reasons. An Order-Greedy algorithm as described herein may modify an ordering of the agents for assistance. In one example, processing circuitry 205 implements the Order-greedy algorithm by modifying an ordering of multiple agents of the architecture based on performance information.

Processing circuitry 205 may apply the minimization solution described herein to determine whether machine learning model 219 and/or learner unit 221 minimize the in-sample prediction loss in satisfaction of one or more criterion (e.g., a threshold) and if so, machine learning model 219 and/or learner unit 221 is sufficiently trained and/or built for deployment into the first agent's services.

In some examples, processing circuitry 205 repeat the sending and the receiving steps while updating machine learning model 219 and/or learner unit 221 (e.g., at each iteration) until an out-sample error satisfies a (stopping) criterion. The out-sample error may be computed by cross-validation. In some examples, processing circuitry 205 may stop repeating the sending and the receiving steps upon confirming satisfaction of the above stopping criteria and/or another set of criteria (NO of 310).

Processing circuitry 205 generates, based on the updated machine learning model, a predicted label set for a new feature set (312). When the first agent deploys a fully-trained machine learning model 219 and/or fully-built learner unit 221 into a machine learning service that is accessibly by other agents of the same architecture, the first agent uses machine learning model 219 and/or learner unit 221 to make various predictions regarding another agent's service request and then, return some response to direct the other agent.

Processing circuitry 205 may query at least one agent for each to provide a second predicted label set and determine a final prediction label set (314). In one example, processing circuitry 205 uses machine learning model 219 and/or learner unit 221 (e.g., function ‘ƒ’) to predict a set of expected labels based upon new feature sets. In one example, processing circuitry 205 generates, from a new feature vector, and the learner unit 221, a first set of predicted labels based on machine learning model 219 and/or learner unit 221. The new feature set may include one or more input features (e.g., predictors) for new sample data corresponding to a new person (e.g., a user or a patient) and/or a new timestamp such that when the processing circuitry 205 applies one or more machine learning models 219 and/or learner unit 221 to the new feature set, processing circuitry 205 generates the first predicted label set. The first agent may employ the final updated machine learning model 219 from the training process or any combination of machine learning models 219 from the same training process. The first agent may use the above first predicted label set to complete the service request or query other agents of the same architecture for assistance.

In some examples, the first agent may decide to seek assistance from at least one agent to gain more intelligence before completing the service request and to that end, processing circuitry 205 may query at least one agent for each to return a second predicted label set from which learner unit 221 may determine a final prediction result (314). Via assisted learning protocol, processing circuitry 205 may submit the queries to at least one computing device operating one or more modules of the architecture and obtain, as a response from each agent, the second predicted label set for the new feature set.

The present disclosure provides a number of non-limiting examples where, to compute the final prediction label set for the new feature set, processing circuitry 205 may combine the first predicted label set and the second predicted label set into the final prediction label set. In one example, in response to a new sample, processing circuitry 205 may generate a new feature vector (e.g., a tuple/set of features of the new sample) and apply separate machine learning models for a first predicted label and at least one second predicted label and combine the separate model results in some manner to generate a final predicted label for the new feature vector. An example second predicted label may be based on an aligned feature vector or a partially aligned feature vector of a same timestamp of the new sample. In some examples, processing circuitry 205 may employ a function to combine, mathematically, the first predicted label with the second predicted label into a final predicted label. In another example, processing circuitry 205 may employ a network ensemble in which a neural network is configured to combine the first predicted label vector with the second predicted label vector into the final predicted label vector.

The above can be contextualized with the following examples. The above computing device may be an intensive care unit (ICU) at a hospital and is developing a module to predict the length of in-hospital stay, using its collected patient data. The ICU employs learner unit 221 to benefit from diverse information sources including other in-patient/out-patient entities, such as a pharmacy or a laboratory. The ICU and at least one of these entities form a portion of machine learning architecture 100 and have many overlapping patients that can be collated by identifiers (e.g., email and username). If the pharmacy provides the ICU with assisted learning, both entities may utilize separate feature sets from decentralized datasets; however, neither the ICU nor the pharmacy will share their private data and models. This may be true even if the hospital and the pharmacy are a part of a single organization (e.g., as divisions), use centralized datasets, and/or similar features. They may use the assisted learning protocol 209 of so that the pharmacy can assist the ICU can improve its predictive accuracy.

During the training stage, processing circuitry 205 may update the function ‘ƒ’ and/or the machine learning model 219 for the learner unit 221 to better fit any received statistical information. In one example, the number of iterations can be limited based upon an information set amongst all modules (including computing device 200 and any remote computing device). In one example, processing circuitry 205 repeats the sending and the receiving until an out-sample error no longer decreases.

After the number of iterations has elapsed, processing circuitry 205 proceeds to a prediction stage, indicating to the machine learning architecture that the learner unit 221 is sufficiently trained and deployable as either a service module or a user module in the machine learning architecture. During this stage, processing circuitry 205 of computing device 200 provides various services in response to requests from agents operating as user modules.

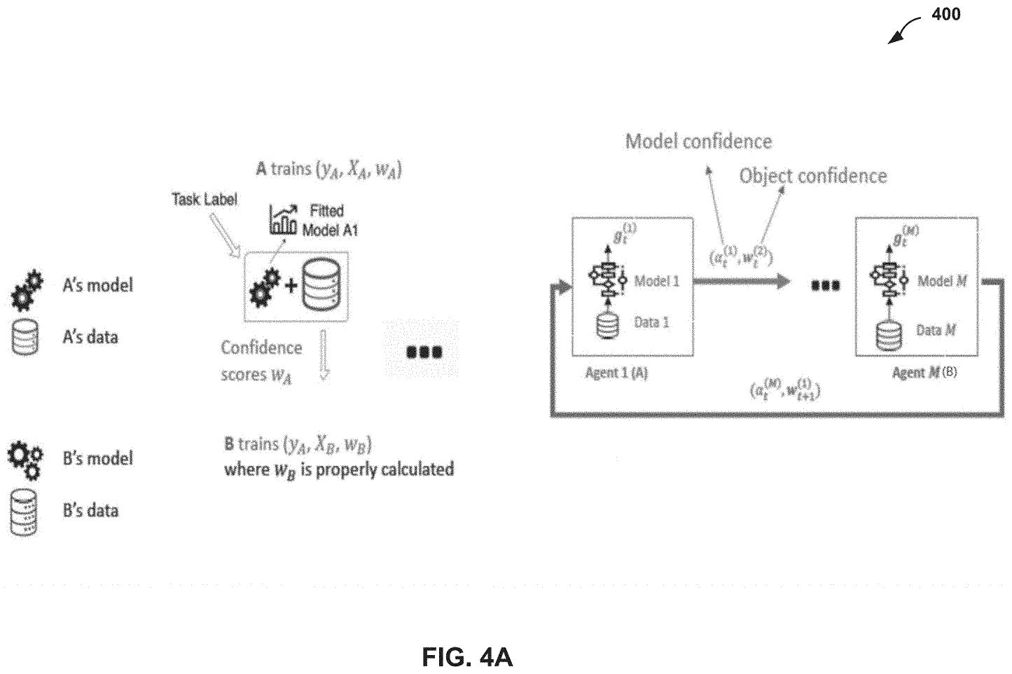

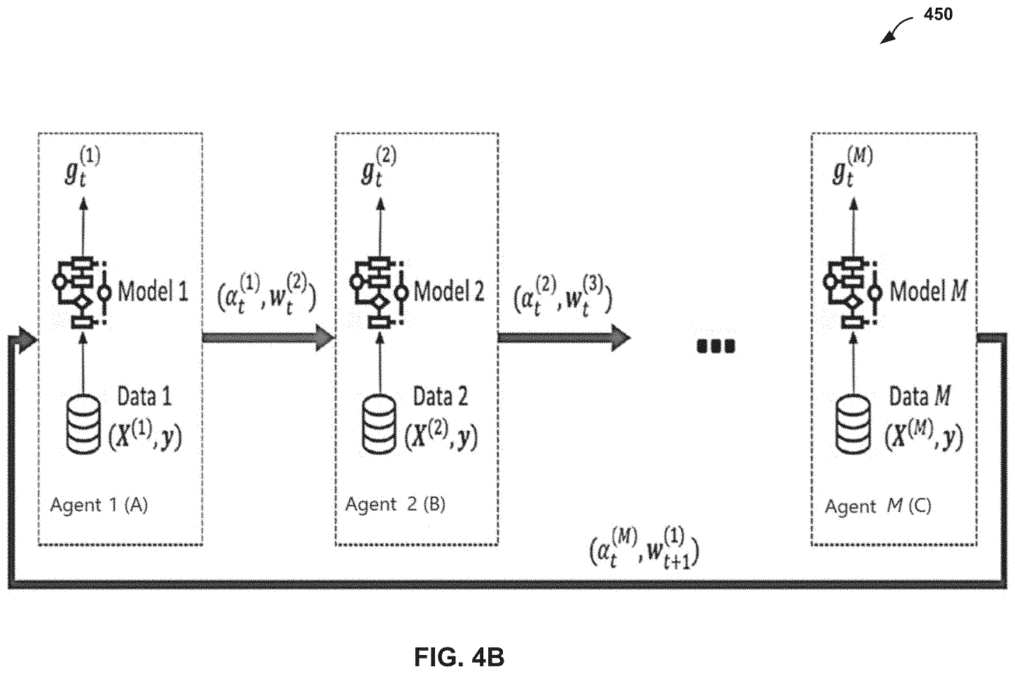

FIG. 4A and FIG. 4B are both block diagrams illustrating two-agent scenario(s) 400 and multi-agent scenario(s) 450 for assisted learning in an example architecture of FIG. 1A or 1B, in accordance with one or more techniques of the disclosure. Computing devices of the example architecture may operate computing services for other computing devices and may use machine learning resources to complete service requests corresponding to training at least one machine learning model. As described herein, the example architecture may enable an assisted learning protocol (e.g., codified in assisted learning protocol 209 of FIG. 2) amongst the computing devices (e.g., agents) of different entities such that two or more agents may perform at least one training process for at least one agent's local model.

In the example architecture for FIG. 4A and/or FIG. 4B, each agent represents a networked computing device on which machine learning resources, including the assisted learning protocol, effectuate the example training processes described herein. Each computing device executes one or more hardware/software components for running a learner unit, a mechanism through which the example training process is coordinated, as part of the example architecture. To gain an advantage when training as demonstrated herein, a first agent in the two-agent scenario described for FIG. 4A may engage in confidence-based assistance learning with a second agent that belongs to a same machine learning architecture. With respect to the multi-agent scenario in FIG. 4B, a first agent may engage in confidence-based assisted learning with multiple other agents who propagate upstream their confidence scores until a last agent is reached, returning to the first agent an updated confidence score of the first agent's model and a model parameter (e.g., a model weight) for the last agent's model and objective.

According to two-agent scenario 400 depicted in FIG. 4A, the computing device of m^{th} agent may instantiate a learner unit to run the example training process for training the m^{th} agent's local model. FIG. 4A further depicts the example training process as an iterative process of which a single iteration is depicted in left half-portion and the iterative process in its entirety is depicted in right half-portion. In each iteration, the m^{th} agent's learner unit first learns a local model given a current confidence score and then, derives a corresponding model weight to minimize the m^{th} agent's in-sample prediction loss. The same learner unit calculates new confidence scores and passes them to another agent. With the new confidence scores, the other agent can focus more on the samples that cannot be well-modeled by the m^{th} agent, and correspondingly update the local model and the model weight. The other agent then updates and then, passes the new confidence score to the m^{th} agent at the next round of iteration.

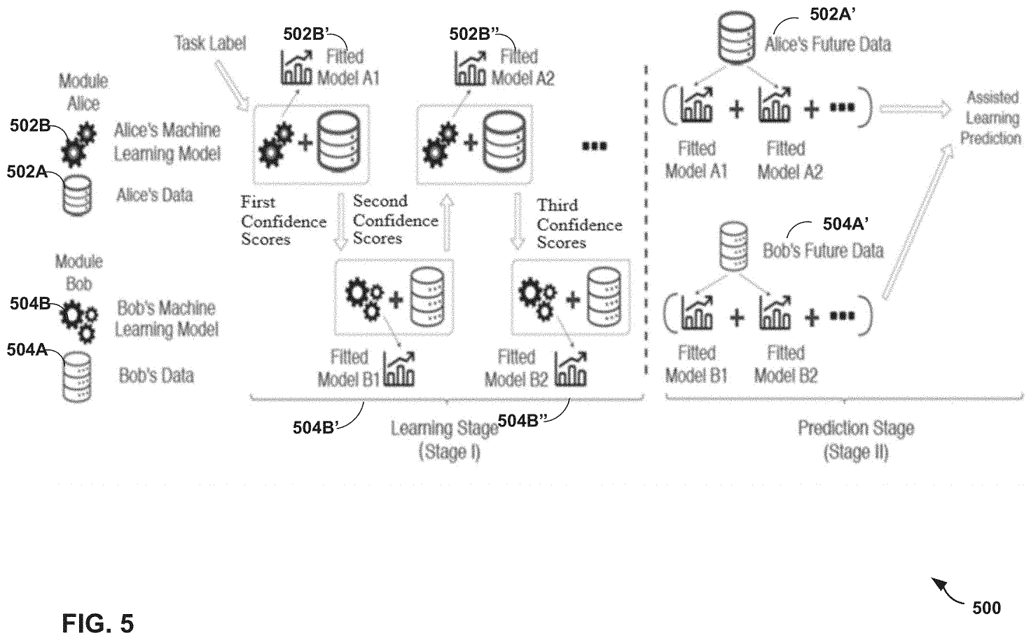

The following describes a number of concepts forming a foundation for the assisted learning protocol on which two or more agents coordinate a training process in either two-agent scenario(s) 400 or multi-agent scenario(s) 450. The following description sets forth these concepts, first, by describing an example framework on which the assisted learning protocol may run on the example architecture consisting of multiple agents and then, by describing the iterative process for training machine learning models and building efficient learner units using the framework. These concepts include definitions, functions, equations, algorithms, and/or the like that may be used for programming an agent's learner unit to instantiate the assisted learning protocol, for example. In one example, programmable hardware/software components of a learner unit may be properly configured by transforming the concepts into processor-executable instructions directed to performing specific operations when used for a number of training processes. Algorithm 1 and Algorithm 2, which are described in detail for FIG. 5, are examples of such specific operations.

In general, the two or more agents may run learner units to perform each iteration of the training process and by way of the assisted learning protocol, control the exchange of statistical information over a number of iterations. The following description includes confidence values as an example of the statistical information; it should be noted that other task-related statistics may be used in the assisted learning protocol and exchanged in the example training process. For this reason, the assisted learning protocol may be referred to herein as a confidence-based assisted learning protocol. The confidence-based assisted learning protocol defined herein may operate using the following notations for agents and their learner units and machine learning models.

Suppose there exist M (total) agents in the example architecture where m=1, . . . , M, the m^{th} agent maintains local model gₙ^{(m)}(which may be denoted as g^{(m)}, gₙ, or simply g) for training, in either two-agent scenario 400 or multi-agent scenario 450, and making accurate predictions/conclusions from feature sets of (local) user data that the m^{th} agent holds as

X^{(m)}=[x₁^{(m))}, . . . ,xₙ^{(m)}]^{T}∈ [symbol] ^{n×p}^{ₘ},

which denotes a private data matrix where n is the sample size and Pₘ is the number of feature variables. As explained in more detail below, m^{th} agent receives assistance from the example architecture having insights into a different agent's local user data, which is unavailable to the m^{th} agent. Therefore, the m^{th} agent benefits from having other agents in the example architecture, for example, by using the assistance provided by at least one other agent to improve the local model (at least) with better training and to make more accurate predictions/conclusions from the local user data.

The following notation sets forth the goal or task of the m^{th} agent which can be defined as a classification problem; given that one example prediction/conclusion may be of, or somehow relate to, a quantity or quality, each possible outcome is an output class of the classification problem that involves K classes (e.g., K≥2).

For training the local model to solve the classification problem, the protocol defines a K-class label vector c as c=[c₁, c₂, . . . , cₙ]^{T} that is accessible by all the agents, where cᵢ∈{1, 2, . . . , K}. The protocol may re-code the label vector c (e.g., for observed labels) into a label matrix Y=[y₁, y₂, . . . , yₙ]T where each row yᵢ=[ [symbol] ᵢ₁, [symbol] ᵢ₂, . . . , [symbol] _{iK}]^{T} and each element

$${y}_{ij} = \{ \begin{matrix}1 , & {c}_{i} = j \\ - \frac{1}{K - 1} , & {c}_{\dot{i}} \neq j\end{matrix}$$

encodes the class cᵢ. Consequently, the original class label is represented by one of the following encoding vectors,

$$𝒴 = \{ \begin{matrix}{( 1 , - \frac{1}{K - 1} , - \frac{1}{K - 1} , … , - \frac{1}{K - 1} )}^{T} \\ {( - \frac{1}{K - 1} , 1 , - \frac{1}{K - 1} , … , - \frac{1}{K - 1} )}^{T} \\ … \\ {( - \frac{1}{K - 1} , - \frac{1}{K - 1} , - \frac{1}{K - 1} , … , 1 )}^{T}\end{matrix} \} .$$

In the above encoding matrix, [symbol] is a K-element feature set of K-dimensional vectors where each sample provides data for a number of features and y∈ [symbol] . One reason to use this encoding method is for technical convenience when implementing the exponential loss. The above code format has been widely used for multi-class classification tasks, e.g., support vector machines and boosting.

By setting the vector c, the M agents may exchange various information including, but not limited to, the confidence scores defined herein. Other statistical information may be exchanged as well as non-statistical information, such as information on how to reach a consensus on how to collate/align the user datasets into feature sets through a certain data ID (e.g., person ID or timestamp). The M agents may generate learner units and machine learning resources to support operations of the assisted learning protocol defined herein. The learner unit may be a hardware/software component configured to train the local model g to better predict a quantity or quality as one or more output classes of the classification problem that involves K classes.

As demonstrated in the following description, the in-sample prediction loss may be codified as an objective function setting forth at least one criterion for training the local model g. Solving the objective function, which involves determining a particular set of inputs that satisfy the at least one criterion, minimizes the prediction loss that may result from updating a model with those inputs. In some examples, the in-sample prediction loss per sample may accumulate into an approximate exponential loss distribution.

In one example, the m^{th} agent may execute a training process for current local model g, that minimizes the in-sample prediction loss with the objective function. The m^{th} agent may solve the objective function by searching and then, finding new/replacement values for the local model parameters (e.g., weights) that if implemented, would result in an updated local model with a lowest in-sample prediction loss amongst other possible updated local models. A learner unit of the m^{th} agent may evaluate a number of potential updated local models in terms of accuracy thought a variety of mechanisms, such as by comparing an expected label set gₜ₊₁^{(m)}(Xₜ₊₁^{(m)}) with the observed label set y∈ [symbol] . The learner unit may determine whether the objective function is satisfied by any of the potential updated local models, and if so, the learner unit may select the updated located model that minimizes the in-sample prediction loss and finalize the update to the current local model. One example loss function for modeling the in-sample prediction loss may be an exponential loss function that is configured to identify a set of updated model parameter values that results in minimal exponential loss.

Although the m^{th} agent's local model g is trained on all the data in the example scenario, the agent's learner unit requires the local model g to be trained only on that agent's data. While agents of a conventional architecture may have to collate their feature data (including private feature sets), the assisted learning protocol described herein allows agents of the example architecture to maintain data privacy and forego collation. The protocol may enable such data privacy by defining an objective function that apparently involves all the data, but it actually only requires each learner unit to model on its data and interchange some summary statistics.

Specifically, the objective function may determine a solution to an empirical risk minimization problem that involves the following model class of (supervise) functions ƒ_{T} (also referred to as ‘additive models’)

$${ℱ}_{T} = \{ {f}_{T} ( {x}_{i}^{( 1 )} , … , {x}_{i}^{( M )} ) = {\sum }_{t = 1}^{T} {\sum }_{m = 1}^{M} {α}_{t}^{( m )} {g}_{t}^{( m )} ( {x}_{i}^{( m )} ) \}$$

and the exponential loss function

$$ℒ : ( y , {f}_{T} ) \to {e}^{- \frac{1}{K} {y}^{T} {f}_{T}} ,$$

In the above model class of supervise functions ƒ_{T}, model weight αₜ^{(m)}∈ [symbol] ⁺, local model gₜ^{(m)}∈F₀^{(m)}, F₀^{(m)} is the model class for agent m. M is the number of agents, and T is the number of additive model components. One reason the protocol introduces multiple additive components is to expand the generalizability of the supervised function ƒ_{T} where T may be interpreted as the number of learning rounds/iterations determined by a stop criterion. Likewise, the protocol may define an index t to denote the iteration number.

The assisted learning protocol may implement optimization functionality for the example training process. Conventional optimization functionality for [symbol] _{T} becomes intractable. As demonstrated below and in the non-patent literature entitled “ASCII: ASsisted Classification with Ignorance Interchange” which is hereby incorporated by reference, the above empirical risk minimization problem can be transformed into a sequence of the following problems:

$${argmin}_{g ∈ {ℱ}_{0}} {\sum }_{i = 1}^{n} {t , i}_{( m )}^{} exp \{ - \frac{1}{K} {\sum }_{j = 1}^{m} {α}_{t}^{( j )} {y}_{i}^{T} {g}_{t}^{( j )} ( {x}_{i}^{( j )} ) \} .$$

Having exponential loss function [symbol] , the following equation—which may be referred to herein as “equation (1)”—may be derived as an example optimization problem for the above empirical risk minimization problem:

$${argmin}_{{g}_{t}^{( m )} ∈ {ℱ}_{0}^{( m )} , {α}_{t}^{( m )} ∈ {ℝ}^{+}} ℒ ( {y}_{i} , {\sum }_{t = 1}^{T} {\sum }_{m = 1}^{M} {α}_{t}^{( m )} {g}_{t}^{( m )} ( {x}_{i}^{( m )} ) ) .$$

The present disclosure introduces confidence scores as one example implementation for a type of statistical summary information to be exchanged. The following description demonstrates suitability of the confidence scores for the assisted learning protocol and any training process performed thereon.

In some examples, the learner unit of the m^{th} agent may be operative to generate/initialize a local model g by initializing a model weight α and confidence scores included in a confidence score vector w for that model at initialization time. The learner unit of the m^{th} agent may define one or more confidence scores [symbol] ᵢ for vector w and set the initial model weight a to any value above zero (0). The learner unit of the m^{th} agent trains the initialized model g such that gₙ represents an update to a previous model at any iteration and is determined from the following minimization problem:

$${g}_{n} = {argmin}_{g ∈ {ℱ}_{0}} {\sum }_{i = 1}^{n} {i}_{} exp \{ - \frac{1}{K} {α y}_{i}^{T} g ( {x}_{i} ) \} .$$

The learner unit of m^{th} agent solves the example optimization problem using the following minimization problem (as an equivalent):

$${argmin}_{g ∈ {ℱ}_{0}} {\sum }_{i = 1}^{n} {i}_{} \vert \vert \{ {y}_{i} \neq g ( {x}_{i} ) \} .$$

The present disclosure introduces the above as a proposition (hereinafter denoted as “Proposition 1”) that if the aforementioned exponential loss function [symbol] is used in the above first optimization function for resolving the above empirical risk minimization problem, each update of the local model g works toward minimizing the average classification error weighted by the confidence score (e.g., and any other weight), thereby reducing that minimization problem to one with a more efficient and/or known solution. A Proof for such a proposition can be found as part of supplementary material in the non-patent literature entitled “ASCII: ASsisted Classification with Ignorance Interchange” and has been incorporated by reference in its entirety. This Proof demonstrates the above minimization problem's quality as a solution to the example first optimization function. For at least this reason, the learner unit may omit the model weight α from the example optimization function and instead, use no (additional) weight value or set the model weight α to any fixed value according to some examples.

It should be noted that a reward value r may be computed for each sample i for expressing an overall improvement to an updated local model from a single iteration of the training process, according to some examples. As a general case, during iteration t of the above training process, the learner unit of the m^{th} agent may, for given sample (index) i, determine a corresponding prediction reward whose value indicates a prediction accuracy of the updated local model/new current local model. Specifically, in the above example, the prediction accuracy refers to an accuracy of an expected label determined by the updated local model/new current local model for that sample i; therefore, the learner unit of agent A may compute the prediction accuracy by comparing the expected label with an observed/actual label for the given sample i. In the same example or in a different example, the learner unit may compute the sample's corresponding reward to represent the gain in prediction accuracy realized from implementing the updated local model over other models (e.g., the current local model of iteration t−1 or a previous iteration). Having an expected label determined by the previous current model of iteration t−1, the learner unit of agent A may determine an amount of the realized gain by computing a (positive) difference between the previous expected label and the expected label of the updated local model.

To illustrate by way of one example solution, the following provides a specification for a stage-wise approach that calibrates (e.g., current mappings of) the local model gₜ⁽¹⁾ as well as any model parameter, such as the current model weight αₜ⁽¹⁾ and further describes the learner unit of the m^{th} agent adopting the approach. Based on the confidence score vector [symbol] ₜ⁽¹⁾ that is derived during iteration t−1, the learner unit of the m^{th} agent calibrates model parameters in accordance with the following first optimization function:

$${argmin}_{{g}_{t}^{( 1 )} ∈ {ℱ}_{0}} {\sum }_{i = 1}^{n} {t , i}_{( 1 )}^{} exp \{ - \frac{1}{K} {y}_{i}^{T} {α}_{t}^{( 1 )} {g}_{t}^{( 1 )} ( {x}_{i}^{( 1 )} ) \} .$$

The m^{th} agent may use the calibrated model parameters (e.g., model weight αₜ⁽¹⁾ to determine/update a confidence score [symbol] _{t,i}⁽²⁾ for another agent's model. The m^{th} agent may receive confidence score [symbol] _{t,i}⁽²⁾ and proceed to calibrate its model parameters in accordance with the following second optimization function:

$${argmin}_{{g}_{t}^{( 1 )} ∈ {ℱ}_{0}} {\sum }_{i = 1}^{n} {t , i}_{( 1 )}^{} exp \{ - \frac{1}{K} {y}_{i}^{T} {α}_{t}^{( 1 )} {g}_{t}^{( 1 )} ( {x}_{i}^{( 1 )} ) - \frac{1}{K} {y}_{i}^{T} {α}_{t}^{( 2 )} {g}_{t}^{( 2 )} ( {x}_{i}^{( 2 )} ) \} .$$

Since model gₜ⁽¹⁾ and model parameter αₜ⁽¹⁾ are privately held by m^{th} agent, solving the second optimization function may be intractable for the other agent. It should be noted that the second optimization function may become intractable due to multiple local models requiring simultaneous optimization. If the protocol allows the m^{th} agent to recode another confidence score vₜ⁽²⁾={vₜ⁽²⁾}ᵢ₌₁ⁿ with

$${v}_{t , i}^{( 2 )} = \frac{exp \{ - \frac{1}{K} {y}_{i}^{T} {α}_{t}^{( 1 )} {g}_{t}^{( 1 )} ( {x}_{i}^{( 1 )} ) \}}{{\sum }_{i = 1}^{n} exp \{ - \frac{1}{K} {y}_{i}^{T} {α}_{t}^{( 1 )} {g}_{t}^{( 1 )} ( {x}_{i}^{( 1 )} ) \}} ,$$

The m^{th} agent may then send confidence scores vₜ⁽²⁾ and [symbol] ₜ⁽²⁾ to the other agent. The other agent may forgo using the second optimization function and rely on an alternative optimization function from which the other agent derives its new confidence score [symbol] ₜ₊₁⁽¹⁾ for the m^{th} agent's model is as follows:

$${argmin}_{{g}_{t}^{( 2 )} , {α}_{t}^{( 2 )}} {\sum }_{i = 1}^{n} {t , i}_{( 2 )}^{} {v}_{t , i}^{( 2 )} exp \{ - \frac{1}{K} {y}_{i}^{T} {α}_{t}^{( 2 )} {g}_{t}^{( 2 )} ( {x}_{i}^{( 2 )} ) \} .$$

In some examples, the example training process enables additional alternatives to the above first and second optimization functions. Some alternatives may be considered further optimized than their counterpart first or second optimization function. The following describes optimization functions that incorporate rewards to calibrate model parameters. Based on the other agent's new confidence score and model parameter αₜ⁽²⁾, the m^{th} agent may update confidence score [symbol] _{t,i}⁽²⁾ into [symbol] _{t+1,i}⁽²⁾ according to results of the above first optimization function and/or from fitting the model's updated label set (y₁, X₁, W₁) with the observed label set. Given an observed label set in matrix Y, the m^{th} agent's and the other agent's feature sets in covariate matrices X⁽¹⁾, X₍₂₎, model functions in model classes F₀⁽¹⁾, F₀⁽²⁾ and loss functions l⁽¹⁾, l⁽²⁾, under the stage-wise additive modeling scheme, each iteration may involve computing model weights and other model parameters and confidence scores.

Any agent practicing the stage-wise additive modeling scheme may use the following equations (which are referenced herein as equations (2). (3), (4). (5), and (6)) may be used to compute that agent's model weight and confidence score(s) during a single iteration:

$${α}_{t , i}^{( 1 )} = log ( {\overline{r}}_{t}^{( 1 )} / ( 1 - {\overline{r}}_{t}^{( 1 )} ) ) + log ( K - 1 ) ; \qquad ( 2 )$$

$${t , i}_{( 2 )}^{} = \frac{{t , i}_{( 1 )}^{} {e}^{( 1 - {r}_{t , i}^{( 1 )} ) {α}_{t}^{( 1 )}}}{{\sum }_{i = 1}^{n} {t , i}_{( 1 )}^{} {e}^{( 1 - {r}_{t , i}^{( 1 )} ) {α}_{t}^{( 1 )}}} ; \qquad ( 3 )$$

$${v}_{t , i}^{( 2 )} = \frac{{e}^{( 1 - {r}_{t , i}^{( 1 )} ) {α}_{t}^{( 1 )}}}{{\sum }_{i = 1}^{n} {e}^{( 1 - {r}_{t , i}^{( 1 )} ) {α}_{t}^{( 1 )}}} ; \qquad ( 4 )$$

$${α}_{t , i}^{( 2 )} = log ( {\overline{r}}_{t}^{( 2 )} / ( 1 - {\overline{r}}_{t}^{( 2 )} ) ) + log ( K - 1 ) ; and \qquad ( 5 )$$

$${t , i}_{( 1 )}^{} = \frac{{t , i}_{( 2 )}^{} {e}^{( 1 - {r}_{t , i}^{( 2 )} ) {α}_{t}^{( 2 )}}}{{\sum }_{i = 1}^{n} {t , i}_{( 2 )}^{} {e}^{( 1 - {r}_{t , i}^{( 2 )} ) {α}_{t}^{( 2 )}}} . \qquad ( 6 )$$

In the above equations (2)-(5), gₜ⁽¹⁾, rₜ⁽¹⁾ and gₜ⁽²⁾, rₜ⁽²⁾ represent the m^{th} agent's and the other agent's respective local models and reward values. The protocol described herein may implement a number of methods to generate values for both terms. Algorithm 2 (which is reprinted and described in further detail below for FIG. 5) is one example method configured to output gₜ⁽²⁾, rₜ⁽²⁾ and gₜ⁽²⁾, rₜ⁽²⁾.

The foundation described above further enables agents to build and operate different embodiments of a confidence-based assisted learning protocol. Based on the notations, definitions, etc. presented herein, there may be a number of variants and alternatives/options to model definitions and data definitions that are compatible and/or equivalent with the protocol described herein. For instance, there may be a single type of statistical summary information that is suitable to enable the assisted learning protocol or a plurality of different types of such statistical summary information.

After implementing the above foundation for the confidence-based assisted learning protocol, at least two agents can exchange statistical information to assist in training their local models, for example, by way of a number of example scenarios. FIG. 4A includes at least one two-agent scenario 400 for the confidence-based assisted learning protocol in which two agents, denoted as A and B, define the above-mentioned objective function for the example training process. FIG. 4B, similarly, includes at least one multi-agent scenario 450 for the confidence-based assisted learning protocol in which three agents, denoted as agents A, B, and C, define an objective function for the example training process configured to efficiently build each agent's local model. Both A and B (and C) may define the same objective function for the example training process. It should be noted that incorporating the same objective function as described herein enables each agent's local model (or only A's local model) to be built efficiently.

In the examples presented in FIG. 4A and/or FIG. 4B, A and B represent networked computing devices on which each agent implements machine learning resources, including the assisted learning protocol, to effectuate the example training processes described herein, for instance, where agent B (or simply “B”) assists agent A (or simply “A) in training A's local model by iteratively exchanging confidence scores with A.

In FIG. 4A and/or FIG. 4B, A may request and receive side information, and B may provide appropriate assistance as a service. Specifically, B assists A in building its local model, which may be defined as the label set (y_{A}, X_{A}, W_{A}) Agents A and B may record data that the protocol may define as respective features vectors xᵢ^{(A)}∈ [symbol] ^{P}^{_{A}} and xᵢ^{(B)} [symbol] ^{P}^{_{B}} and observed label set yᵢ where i is the number of samples and dimensions P_{A} and P_{B} are arbitrary and may each be any positive integer. The protocol may further define joint datasets between agents A and B. Thus, a learner unit for A may be configured to build an initial version of the local model that incorporates feature vector X_{A} to generate an initial label vector y_{A} and then, leveraging the assistance from a learner unit of B, is iteratively updated, ultimately, to reach an objective (e.g., an accurate (final) label vector y_{A}). The learner unit for A may derive an initial model weight, for example, with an objective to minimize A's in-sample prediction loss. At a first iteration, A may compute confidence scores based on the initial model weight and send B those confidence scores. B, given those initial confidence scores, B continues training its local model including samples that cannot be well-modeled by A, and derives a new model weight after completing the update to the local model. B may determine the model weight by updating a first expected label set and fitting the B's updated expected label set to an observed label set. B updates the initial confidence score and then, passes the new confidence score to A for the next iteration. At each subsequent iteration, given a current confidence score. A continues training the local model and then, derives a new model weight to minimize the in-sample prediction loss. A computes a new confidence score and then, sends the new confidence score to B to complete the current iteration. B updates the received confidence score according to A's results and then, determines optimal values for (local) model parameters.

The learner unit of agent A, from fitting an initial label set of model g with the observed label set, determines a reward value r for each sample i and to reflect the progress made in training the model g to predict a corresponding observed label for that sample. The reward value r may be computed by minimizing an empirical risk in the fitted model g₁ then, determine an appropriate model weight for the model parameter α₁ for the above example first optimization function. In the above example, the prediction reward r may refer to a value or benefit conferred to the learner unit of agent A for selecting the updated model g₁ as the new (current) local model, for instance, for further training at a next iteration t+1—unless the learner unit determines that the current local model satisfies the stop criterion and then, halts the training process from progressing past the next iteration. A function or series representing the prediction reward(s) may be a length-n vector that describes how the local model performs on each sample i of n samples.

In addition, A and B (and C) may each configure the example training process to model the same input data, but each agent may limit their local model to making predictions on only their (private) data; thus, by limiting the example training process to samples from their private data, each agent may forego extraneous/unnecessary computations and run only part of the example training process. To successfully train each local model until both local models are capable of making accurate predictions, the example training process may direct both all agents A and B or A, B, and C to alternate the training/updating of their local models for a number of iterations, ultimately, to generate a solution for the objective function, according to some examples. This solution may involve satisfying at least one criterion/condition, for example, by minimizing or maximizing the objective function until a threshold is reached.

According to the confidence-based assisted learning protocol described herein, A may calibrate A's local model gₜ⁽¹⁾ and model parameter αₜ⁽¹⁾ with a loss function and a confidence score [symbol] _{t,i}⁽¹⁾ derived at iteration t−1 by B. In this example, the model parameter αₜ⁽¹⁾ is a model weight representing model confidence; specifically, the model weight attributed to A's local model gₜ⁽¹⁾ is a value indicating the local model's accuracy in modeling the sample space of its feature set. In this example, the confidence score [symbol] _{t,i}⁽¹⁾ represents object confidence; specifically, the confidence score assigned to A's local model gₜ⁽¹⁾ is a value indicating that local model's accuracy in predicting the observed label set. It is not a requirement in the following example for the loss function to be an exponential loss function although some examples benefit from incorporating the exponential loss function to optimize the empirical risk minimization problem.

In an example where the model weight α may be set to a pre-determined value, that pre-determined value remains unchanged throughout the example training process (with possible exception of the initial model weight value). In this example, the learner unit of agent A may update (current) local model gₜ₋₁ at iteration t, resulting in updated model gₜ, using (only) prediction reward(s) and confidence score(s).

The two-agent scenario 400 depicted in FIG. 4A includes an abstract representation of the assisted learning protocol, specifically for performing the example training process over a number of iterations (as depicted in a right half); a single iteration thereof (as depicted on a left half) includes A's model built on A's data undergoing an update with assistance from B and their own private model and data. In general, mathematical models including machine learning models may be denoted as sets, specifically label sets in a format of (labels, samples) or (y, X). The present disclosure, in accordance with the above foundation defining the confidence-based assisted learning protocol, introduces an appropriate format, label set (yᵢ, Xᵢ, wᵢ), for an expression of a generic agent's model. Applying the same format to two-agent scenario 400 of FIG. 4A, the example training process represented in that scenario is depicted as training label sets (y_{A}, X_{A}, W_{A}) and (y_{B}, X_{B}, w_{B}) by having A and B iteratively interchanging confidence scores W_{A} and w_{B}, respectively.

For explanatory purposes, FIG. 4A depicts agents 1 and 2 of the assisted learning protocol as assigned to A and B, respectively, in the context of the above definition; however, A and B may correspond to any two of agents 1, 2, . . . , M.

Generally, solving the example first optimization function involves using the current model weight αₜ⁽¹⁾ to update each label gᵢ the local model gₜ⁽¹⁾ and, in furtherance of that model's training, repeating the model weight update for a number of iterations (t) in succession. The training process for the local model may progress until a pre-determined and/or fixed stop criterion is satisfied at which the training process may terminate/pause.

The above describes the example training process of FIG. 4A as part of a staged approach to optimize agent A's local model gₜ⁽¹⁾ and model parameter αₜ⁽¹⁾ during a training stage. When agent A determines that its local model is sufficiently trained, ending the training stage and commencing a prediction stage, agent A may execute an evaluation process in response to a new feature vector. During the prediction stage, which is described in further detail for FIG. 5, agent A aggregates a prediction result (e.g., a predicted label) from its local model gₜ⁽¹⁾ and from B's local model gₜ⁽²⁾ to produce a final prediction label.

The following provides details for performing the other example training process in multi-agent scenario 450. The same agent, A, described for FIG. 4A may engage with multiple agents, B and C, in another example training process and gain additional advantages. According to multi-agent scenario 450 as illustrated in FIG. 4B, A sends its confidence scores (w₁, v₁) to agent B, which updates its model parameters and determines new or updated confidences scores (w₂, v₂) that are sent to a next agent, agent C. In a same iteration, agent C updates agent B's confidence scores for C's model and objective/task and then, updates its own confidence scores of agent D's model and objective. Eventually, agent M returns an updated model weight and confidence for agent A to use in training its model. Agent M may also return an updated confidence score of A's objective, if possible, and other model parameters based on the confidence scores from agent M−1.

Assuming a same machine learning (model) objective/task/service and a same objective function as above for the two-agent scenario, some examples of multi-agent scenario(s) 450 involve multiple agents 1, . . . , M transferring confidence scores along a chain of agents A-M such that a last agent M may transmit a latest confidence score to a first agent A, who will then initialize a new iteration or proceeds to the prediction stage. M agents, having access the label vector Y=[y₁, y₂, . . . , yₙ]^{T}∈ [symbol] ₙ, may each hold a private data matrix X^{(m)}=[x₁, x₂, . . . , xₙ]^{T}ε [symbol] ^{n×p}^{ₘ} with model weight(s) αₜ^{(m)}, local model gₜ^{(m)}, model class F₀^{(m)} and loss function [symbol] ^{(m)} for m=1, 2, . . . . M.

At iteration t, for agent m, under the stage-wise additive modeling scheme, the optimization function for the agent m can be expressed as

$${argmin}_{{g}_{i}^{( m )} , {α}_{i}^{( m )}} {\sum }_{i = 1}^{n} ℒ ( {y}_{i} {f}_{t - 1} ( {x}_{i}^{( 1 )} , … , {x}_{i}^{( M )} ) + {\sum }_{j}^{m} {α}_{i}^{( j )} {g}_{i}^{( j )} ( {x}_{i}^{( j )} ) )$$

where ƒₜ is defined above as model functions. Under the stage-wise additive modeling scheme, at iteration t, agent m receives the confidence score wₜ^{(m)} from agent m−1 (or from agent Mat iteration t−1 if m=1) and minimizes the exponential in-sample prediction loss of the additive models until gₜ^{(m)}. Since gₜ^{(j)} for j=1, 2 . . . m−1 is not known a priori for agent m, the minimization for agent m can be re-expressed as

$${argmin}_{{α}_{i}^{( m )} ∈ {ℝ}^{+} , {g}_{i}^{( m )} ∈ {F}_{0}^{( m )}} {\sum }_{i = 1}^{n} {t , i}_{( m )}^{} {v}_{t , i}^{( m )} {e}^{- \frac{1}{K} {y}_{i}^{T} {α}_{i}^{( m )} {g}_{i}^{( m )} ( {x}_{i}^{( m )} )}$$

where wₜ^{(m)} is a set (e.g., a vector) of model confidence scores and vₜ^{(m)} is a set (e.g., a vector) of object confidence scores at iteration t for each sample. Agent M−1 may provide both confidence scores after deriving them from other parameters, including the confidence scores of a previous agent m−2. After agent M updates its local model gₜ^{(m)}, agent M returns to agent A an updated model confidence score and an updated model weight for agent M's local model gₜ^{(m)}.

Amongst the distinguishing aspects of multi-agent scenario 450, instead of agent A and agent B sending and receiving each other's confidence scores, agent C also provides agent A with assistance. In one example, agent C may send confidence score of C's model (e.g., a model weight) to agent A or agent B to help train A's model or B's model, respectively. In one example, agent C may send a confidence score of A's model to B for updating B's model parameters (e.g., model weights), for further calibration, and for return to A or distribution to yet another agent. In one example, agent C may send a confidence score of A's model to A in order to initialize/update A's model for a next iteration.

The assisted learning protocol described herein may enable a number of variants (e.g., in two-agent and/or multi-agent scenarios). This in part because each variant may implement confidence values in the same manner and therefore, exchanges the same confidence scores during training. The assisted learning protocol described herein facilitates training process depicted in FIG. 4B by enabling the confidence score interchange.

Algorithm 1, an example implementation for the assisted learning protocol described herein, is described in detail in the non-patent literature entitled “Assisted Learning: A Framework for Multi-Organization Learning,” which has been incorporated in its entirety. In one example, Algorithm 1 may assume a fixed ordering of m agents for confidence-based assisted learning in multi-agent scenario 450. An inefficient ordering of the m agents for assisted learning may have an effect on performance at any one or more of the m agents. While Algorithm 1 introduced how the information is exchanged between agents, the assistance order at each round of information interchange between M agents are fixed. However, local models for some agents may have poor performance, or the features are uninformative, including those agents contributing less information in Algorithm 1, and might cause early algorithm termination.

As another variant, the assisted learning protocol may configure the m agents to determine an efficient (e.g., optimal) ordering for each iteration's interchange of confidence values. Algorithm 6 is one example of an Order-Greedy ASCII algorithm that can be highly efficient, more robust and easy-to-manage. A description for Algorithm 6 can be found in the non-patent literature entitled. “Assisted Learning: A Framework for Multi-Organization Learning,” which has been incorporated in its entirety.

FIG. 5 is an illustration of a two-stage assisted learning protocol for an example architecture of FIG. 1A or 1B, in accordance with one or more techniques of the disclosure.

Alice 502 and Bob 504 in general represent agents operating as modules and participating in assisted learning protocol 500 by way of learner units, machine learning models, and/or machine learning techniques. Alice 502 and Bob 504 may exchange confidence scores, such as a confidence score indicating model confidence or object confidence. An example confidence score for model 502B or model 504B may indicate how much of datasets 502A or 504A have been modeled.

As depicted in FIG. 5, assisted learning protocol 500 includes a learning stage (i.e., a training process) and a prediction stage (i.e., an evaluation process) for both Alice 502 and Bob 504. Alice 502 and Bob 504 may represent agents A and B of FIG. 4A and FIG. 4B. As described herein, both Alice 502 and Bob 504 include partially aligned (e.g., collated) or fully aligned datasets 502A, 504A that remain independent of each other (e.g., to maintain data privacy). Alice 502 and Bob 504 also include private models 502B and 504B, respectively. An example of these private models may be machine learning model 219 of FIG. 2.

Agents such as Alice 502 and Bob 504 (e.g., specifically one or more hardware/software components therein) may be programmed with processor-executable instructions (e.g., computer code) for assisted learning protocol 500. Alice 502 and Bob 504 may run learner units that are configured to execute various functionality, including Algorithm 1 and Algorithm 2, for the training process (i.e., training stage) and/or the evaluation process (i.e., prediction stage) of the modeling scheme described herein. Further details for Algorithm 1 and Algorithm 2 can be found in the non-patent literature entitled, “Assisted Learning: A Framework for Multi-Organization Learning,” which has been incorporated in its entirety, and reprinted below by way of the following example pseudocode:

Algorithm 1 Two-ASCII: Two-Agent Assisted Classification

input Encoded labels Y = [y₁,...,yₙ]^{T} ∈ [symbol] ⁿ, private data matrix X^{(A)} ∈ [symbol]
^{nXp}^{_{A}}, private loss function [symbol] ^{(A)}, and private function class [symbol] ₀^{(A)} (locally
held by A), and the counterpart X^{(B)}, [symbol] ^{(B)}, [symbol] ₀^{(B)}(locally / privately held
by B), a stop criterion
output Learned gₜ^{(A)} ∈ [symbol] ₀^{(A)},αₜ^{(A)} ∈ [symbol] ⁺ (held by A), gₜ^{(B)} ∈ [symbol] ₀^{(B)},αₜ^{(B)} ∈ [symbol]
⁺ (held by B), for t = 1, .., T (where T is determined by the stop
criterion).
1: Initialize w₁^{(A)} = [ [symbol] _{1,1}^{(A)},..., [symbol] _{1,n}^{(A)}]^{T} = [1/n,..,1/n]^{T} ∈ [symbol] ⁿ.
2: for t = 1, 2, ..., T do
3: A learns a local model gₜ^{(A)},rₜ^{(A)} = WST (Y, X^{(A)},wₜ^{(A)}, [symbol] ^{(A)}, [symbol] ₀^{(A)}), where
WST denotes Algorithm 2.
4: A calculates r̅ₜ^{(A)} = (Σᵢ₌₁ⁿ r₍ₜ₎^{(A)}) /n.
5: A calculates the model weight αₜ^{(A)}from (2), break if αₜ^{(A)} ≤ 0.
6: A sends weight w₁^{(B)} = [ [symbol] _{t,1}^{(B)}, [symbol] _{t,2,}^{(B)},..., [symbol] _{t,n}^{(B)}]^{T} and v₁^{(B)} =
[v_{t,1}^{(B)},v_{t,2}^{(B)},...,v_{t,n}^{(B)}]^{T} to B, where w_{t,i}^{(B)} and v_{t,i}^{(B)} are from (3)(4).
7: B learns a local model gₜ^{(B)},rₜ^{(B)} =
WST (Y,X^{(B)},uₜ^{(B)}, [symbol] ^{(B)}, [symbol] ₀^{(B)}), where u_{t,i}^{(B)} = [symbol] _{t,i}^{(B)}v_{t,i}^{(B)} / Σᵢ₌₁ⁿ [symbol] _{t,i}^{(B)}v_{t,i}^{(B)}.
8: B calculates the model weight αₜ^{(B)} from (5), break if αₜ^{(B)} ≤ 0.
9: B calculates [symbol] _{t+1,i}^{(A)} in (6).
10: B sends wₜ₊₁^{(A)} and αₜ^{(B)}to A.
11: end for

In the above pseudocode, equations (2)-(6) refer to equations (10)-(14) of the non-patent literature entitled, “Assisted Learning: A Framework for Multi-Organization Learning.” Algorithm 1 proceeds to the following example pseudocode representing the prediction stage upon completing the above-described training process of the training stage:
12: In the prediction stage, A predicts a future data label using argmax_{k=1, . . . , K}(p^{(A)}+p^{(B)}ₖ), where p^{(A)}=Σₜ₌₁^{T}α₍ₜ₎^{(A)}gₜ^{(A)}(X^{(A)}) is evaluated by A, p^{(B)}=Σₜ₌₁^{T}α₍ₜ₎^{(B)}gₜ^{(B)}(X^{(B)}) is evaluated by B and sent to A, and p^{(A)}ₖ is k-th element in the p^{(A)}.

According to the above example pseudocode, Algorithm 2 is directed to invoke functionality for Algorithm 2 for which example pseudocode is provided below as an example implementation:

Algorithm 2 WST: Weighted Supervised Training
(Subroutine of Algorithm 1)

```
input Observations of Y = [y₁,y₂,...,yₙ]^{T} ∈ [symbol]  ⁿ, X = [x₁,x₂,...,xₙ]^{T} ∈
Xⁿ and w = [ [symbol]   ₁, [symbol]   ₂,..., [symbol]   ₙ]^{T} ∈ [0,1]ⁿ, training loss function [symbol]  (not
necessarily the exponential loss), supervised model class [symbol]  0 (from X to [symbol]
).
output Supervised function gₙ: X → [symbol]  , reward vector r ∈ {0,1}ⁿ.
1: Solve gₙ from (7) which reduces to
  gₙ=argmin_{g∈F}_{₀} Σⁿᵢ₌₁ [symbol]  ᵢ|| {yᵢ≠g(xᵢ)}
(Proposition 1).
2. Solve the above optimization by the following empirical risk
minimization:
  gₙ = [symbol]    Σⁿᵢ₌₁ [symbol]  ᵢ [symbol]   (yᵢ,g(xᵢ)).
3: Calculate the reward r = [r1,r2,...,rₙ]^{T}, where rᵢ = || {gₙ (xᵢ) = yᵢ}.
```

Equation (7) of the above example pseudocode refers to following minimization problem (e.g., equation (5) in the non-patent literature entitled, “Assisted Learning: A Framework for Multi-Organization Learning,”):

$${g}_{n} = {argmin}_{g ∈ {ℱ}_{0}} {\sum }_{i = 1}^{n} {i}_{} exp \{ - \frac{1}{K} {α y}_{i}^{T} g ( {x}_{i} ) \} .$$

The respective learner units of Alice 502 and Bob 504 may use the above minimization problem to train their corresponding local models g such that gₙ represents an update to a previous model at any iteration i.

Representing an example embodiment for assisted learning protocol 500, the above example pseudocode lists steps of at least the training process described herein. Each step may specify an operation to be performed by the learner unit in Alice 502, Bob 504, or both Alice 502 and Bob 504. Algorithm 1 enable Bob 504 (denoted as “B” in the above example pseudocode) to assist Alice 502 (denoted as “A” in the above example pseudocode) iteratively by exchanging confidence scores with Alice 502. Alice 502 and Bob 504 may program their learner units to customize execution of Algorithm 1 and direct that execution towards certain functionality and/or desired results. One example may configure Algorithm 1 by appropriately selecting a loss function (l) and model representation so that each learner unit can iteratively build a model in hindsight only by local training. The loss function may be any suitable loss function including, but not limited to, the exponential loss function [symbol] used in the above-mentioned first optimization function for resolving the empirical risk minimization problem described for FIGS. 4A-4B.

Although not executable as computer code, the example pseudocode conveys the physical constraint(s) (e.g., regarding computer hardware) and the structural activities/interactions necessary for appropriately developing the computer code implementing Algorithm 1 and Algorithm 2. Algorithm 1 describes how B (i.e., Bob 504) assists A (i.e., Alice 502) iteratively by exchanging confidence scores with A. The key to enabling the technical results in Algorithm 1 is the appropriately chosen loss function and model representation, so that each agent can iteratively build a model in hindsight only by local training.

If X_{A} and X_{B} represent Alice 502's and Bob 504's respective feature datasets 502A and 504A, αₜ^{(A)}gₜ^{(A)}(xᵢ^{(A)}) and αₜ^{(B)}gₜ^{(B)}(xᵢ^{(B)}) may represent weighted (expected) labels from Alice's model 502B and Bob's model 504B, respectively. These weighted labels (e.g., values) may be aggregated into weighted averages Σⱼ^{m}αₜ^{(A)}gₜ^{(A)}(xᵢ^{(A)}) and Σⱼ^{m}αₜ^{(B)}gₜ^{(B)}(xᵢ^{(B)}) and then, calibrated to minimize a loss function (e.g., by adjusting a model weight parameter αₜ^{(A)} for Alice). In effect, the model weight parameter for Alice 502 represents how much of Alice's feature datasets 502 have been modeled.

In the learning stage for assisted learning protocol 500, at a first iteration of k iterations of assistance, Alice 502 generates model 502B, a first machine learning model, as a local model for making predictions for the private data in feature dataset 502A. Assisted learning protocol 500 initializes model 502B to map feature dataset 502A, a first feature set, to a first label set and then, trains model 502B to predict an observed label set. Alice 502, in accordance with assisted learning protocol 500, generates first confidence values by, first, determining an initial model weight and based on that model weight, an initial set of sample weights corresponding to training the model 502B. The initial set of sample weights are interchangeable as the first confidence scores. The initial model weight and the initial set of sample weights are used to compute second confidence scores for a second machine learning model, model 504B, at Bob 504. In particular, Alice 502 uses the initial model weight for fitting the first label set of model 502B with the observed label set and then, determines the first set of sample weights. The first set of sample weights and the first model weight are used to determine a second set of sample weights corresponding to training a second machine learning model at the second agent. Each sample weight of the second set of sample weights reflects Alice 502's confidence in Bob 504's training of model 504 to make a prediction from a corresponding sample.

Referenced herein as equations (2), (3), (4), (5), and (6) (e.g., as defined above for FIGS. 4A-4B), the following may be used to compute the model weight and any confidence score(s) within a single iteration of the training process as exemplified by Algorithm 1:

$${α}_{t , i}^{( A )} = log ( {\overline{r}}_{t}^{( A )} / ( 1 - {\overline{r}}_{t}^{( A )} ) ) + log ( K - 1 ) ; \qquad ( 2 )$$

$${t , i}_{( B )}^{} = \frac{{t , i}_{( A )}^{} {e}^{( 1 - {r}_{t , i}^{( A )} ) {α}_{t}^{( A )}}}{{\sum }_{i = 1}^{n} {t , i}_{( A )}^{} {e}^{( 1 - {r}_{t , i}^{( A )} ) {α}_{t}^{( A )}}} ; \qquad ( 3 )$$

$${v}_{t , i}^{( B )} = \frac{{e}^{( 1 - {r}_{t , i}^{( A )} ) {α}_{t}^{( A )}}}{{\sum }_{i = 1}^{n} {e}^{( 1 - {r}_{t , i}^{( A )} ) {α}_{t}^{( A )}}} ; \qquad ( 4 )$$

$${α}_{t , i}^{( B )} = log ( {\overline{r}}_{t}^{( B )} / ( 1 - {\overline{r}}_{t}^{( B )} ) ) + log ( K - 1 ) ; and \qquad ( 5 )$$

$${t , i}_{( A )}^{} = \frac{{t , i}_{( B )}^{} {e}^{( 1 - {r}_{t , i}^{( B )} ) {α}_{t}^{( B )}}}{{\sum }_{i = 1}^{n} {t , i}_{( B )}^{} {e}^{( 1 - {r}_{t , i}^{( B )} ) {α}_{t}^{( B )}}} . \qquad ( 6 )$$

In general, for each of a number of iterations t, Alice 502 may configure their learner unit to use equation (2) to compute a model weight and equations (3) and (4) to compute Bob 504's confidence scores w, v; in turn, Bob 504 may configure their learner unit to use equations (4) and (5) to compute a model weight and a confidence score for Alice 502. Furthermore, the example pseudocode for Algorithm 2 may define an example function to compute values for gₜ^{(A)}, rₜ^{(A)} or gₜ^{(B)}, rₜ^{(B)}, which represent Alice 502's and Bob 504's respective local models and reward values. Alice 502 and Bob 504 may program their respective learner units to execute the example function for each function call in Algorithm 1 for Algorithm 2. To further explain the above example pseudocode, the following description summarizes the actions taken by the learner units of Alice 502 and Bob 504 during the execution of the training process according to Algorithm 1, Algorithm 2, and equations (1)-(6) as defined herein.

Initially, Alice 502 fits, into model 502B′, model 502B with the set of observed labels and then, determines a first model weight, [symbol] ₜ^{(A)}, derived from a previous first confidence value, for example, by determining model parameters that minimize an empirical risk factor.

The previous first confidence value may be a confidence value for model 502B, and that confidence value may be based on a previous second confidence value for model 502B or an initial first confidence value. In some examples, the first model weight may be set to a current first confidence value, which was determined by Bob 504. After updating model 502B in accordance with updated model parameter and generating model 502B′ to map the feature vectors to an updated expected label set in a function that more accurately predicts an observed label set, Alice 502 may calibrate another model parameter, a second model weight, a), to minimize a loss function (e.g., an in-sample prediction loss). Reward values may be assembled into a reward vector r corresponding to first sample weight vector w) for Alice 502.

In some examples, Alice 502 may generate updated model 502B′ using Algorithm 2 and then, calibrate model parameters including the first and second model weights using Algorithm 1. Algorithm 1 is one embodiment of the example training process described herein for FIG. 4A, and a subroutine of Algorithm 1 named Weighted Supervised Training (WST) is concluded in Algorithm 2. Algorithm 1 and Algorithm 2 are both disclosed herein for confidence-based assisted learning in two-agent scenarios; in addition, Algorithm 2 as an example of a minimization solution such as those described herein.

Equations (3) and (4) define new/updated confidence scores (i.e., sample weights) for the vectors w_{t,i}^{(B)} and v_{t,i}^{(B)} in terms of previous confidence scores, the reward value, and the previous model weight. For subsequent iterations, Alice 502 may compute second confidence scores based on the first confidence scores, an updated reward vector, and an updated first model weight. In Algorithm 1, Alice 502 updates the first model weight to minimize the in-sample prediction loss from fitting model 502B′ with the observed label set and then, updates the second confidence scores for model 504B and Bob 504's objective. Bob 504 may then use equations (5) and (6) to compute updated (e.g., calibrated) model parameters as directed by Algorithm 1.

Alice 502 may pass the second confidence scores to Bob 504 where model 504B is updated into fitted model 504B′. Bob 504 may generate and initialize model 504B as a local model configured to map feature set 504A to a second label set. Bob 504 may be configured to determine a second model weight for fitting, into the observed label set, the second label set of model 504B based on a second learning technique and the first confidence scores. Using one or both the sample weight vectors w_{t,i}^{(B)} and v_{t,i}^{(B)} for the second confidence scores, Bob 504 determines a new sample weight vector w_{t+1,i}^{(A)} as an update for a next iteration of the first confidence values and for updating the first model weight. Bob 504 may proceed to update model 504B and generate model 504B′. In one example, executing a method of empirical risk minimization, Bob 504 uses the second confidence scores to modify at least one model parameter such that a risk factor is minimized and then, generates a reward value for use in minimizing prediction loss. Bob 504 my update at least one other model parameter, including the second model weight configured to minimize a loss function for model 504B′, and then, modify the first confidence score to correspond to model 504B′ and its model parameters, including the updated second model weight. Bob may return the modified first confidence value and the updated second model weight to Alice 502.

In turn, Alice 502 executes Algorithm 2 to fit model 502B′ with the modified first confidence value and generate model 502B″ with updated model parameters. Based on the next iteration of the first confidence value, Algorithm 2 may identify a reduction in an empirical risk factor and generate an updated reward value to account for that reduction. If, in one example, exponential loss is used for the empirical risk minimization, each update of the local model is to minimize the average classification error weighted by the first confidence score. Algorithm 2 may generate model 502B″ with updated model parameters, including the updated first model weight. Alice 502 generates a weighted reward value from the updated reward value to calibrate the first model weight such that the new model weight is configured to minimize the loss function. Alice 502 updates the second confidence scores and proceeds to return the updated second confidence scores to Bob 504. When/if sufficiently trained to accurately predict the observed label set, Alice 502 and/or Bob 504 may forego further training of model 502B″ and/or model 504B″ and conclude the learning stage.

At the end of the learning stage and when a latest (fitted) model (e.g., expected label set) for the feature datasets is an acceptable and approximate prediction of the observed label set or an initial label set (if appropriate), Alice and/or Bob enter a prediction stage. Stage 2 of the stage-wise approach (or the prediction stage) succeeds the training stage when, for example, Alice 502's model 502B″ is determined to be ready for deployment as part of a computing service.

During the prediction stage, in response to a directed service request, Alice 502 sends a query to Bob 504 with an index pointing to aligned or partially aligned feature vector(s) in 504A. Alice 502 may use at least one of model 502B, model 502B′, or model 502B″ to generate at least one first prediction label. Similarly, Bob 504 may invoke at least one of model 504B, model 504B′, or model 504B″ to return to Alice 502 at least one second prediction label. In turn, Alice 502 may combine the at least one first prediction label with the at least one second prediction label to generate at least one final prediction label in a final prediction label set.

There are a number of alternatives and/or extensions for assisted learning protocol 500. To let Alice 502 and Bob 504 simultaneously assist each other, separately run two instances of assisted learning protocol 500 where Alice 502 learns from Bob 504 in one instance and Bob 504 learns from Alice 502 in another instance. If Alice 502 is not cooperative after Bob 504 assists Alice 502 in the training stage, Bob 504 no longer assists Alice 502 in the prediction stage. As another solution, assisted learning protocol 500 may be compatible with mechanisms to bind entities together, so that each one must assist others while it is being assisted.

Assisted learning protocol 500 may extend differential privacy to Alice 502 or Bob 504, securing one or both agents against adversarial attacks. Differential privacy is defined as ensuring that a query result cannot be used to infer much about any individual. While a conventional technique may achieve differential privacy by adding noise, assisted learning protocol 209 may be extended into a privacy-guaranteed algorithm, which can achieve e-differential privacy at each round of iteration, and without significant loss of prediction performance. In some examples, based on Alice 502's model weight and Alice 502's confidence score of Bob 504's model 504B, Alice 502 may invoke an injection from a confidence score w for A's model, A's reward value r, to a confidence score w for B's model. Since the reward r(A) t is decided by Alice 502's local model 502B, the privacy-guaranteed algorithm may be divided into two stages. At the first stage, the agent perturbs the objective function in each local model optimization; At the second stage, each agent perturbs reward after determining the local model.

The present disclosure envisions extension(s) to the two-agent scenarios and multi-agent scenarios of confidence-based assisted learning described herein, one example extension may implement the above privacy-guaranteed algorithm. For example, Algorithm 4 may operate as a mechanism that enables differential privacy in the assisted classification of samples by a local model. Algorithm 3, a subroutine of Algorithm 4, may operate as a mechanism for an agent (e.g., Alice 502) to perturb its local model optimization objective function, and the reward after the local model is gained.

Without this extension, Alice and Bob may possibly expose sensitive information by transmitting/receiving queries and their query results, service requests and results, among other examples. For instance, a query or a query result may include a user's feature data, algorithm inputs/outputs, and/or the like. An adversary may access confidence scores for Alice and/or Bob and infer their reward values, which are based on their local models.

An Order-Greedy Algorithm includes a training process that may be an extension to the above training process (i.e., Algorithm 1) for two-agent scenarios and multi-agent scenarios of confidence-based assisted learning. This extension may be described as implementing an ordering algorithm for agents to provide assistance in a multi-agent scenario. Each possible assistance order may form a branch and the ordering algorithm searches multiple branches for candidate(s) and after each iteration, selects a candidate, updates the multiple branches, and repeats until an efficient (e.g., calibrated) assistance order is determined. In some examples, the ordering algorithm extension may provide Algorithm 1 the assistance order that will most likely yield a highest validation accuracy.

Given the number of performance-affecting factors, accuracy of the learner unit in predicting the final results may be implementation-specific where different variants are enabled by technical aspects, for example, an appropriately chosen loss function, stopping criteria, and an efficient model representation. In this manner, each agent can iteratively build a model in hindsight only by local training.

To illustrate by way of example, various stopping rules are available to assistance learning protocol 500 for limiting the number of iterations over which a training process or an evaluation process is performed, and each stopping rule may affect performance of the training or evaluation processes. Assisted learning protocol 500 may enforce a pre-determined number of iterations between Alice 502 and Bob 504 or may establish a mechanism to determine an effective number of iterations without over-fitting or wasting resources.

The present disclosure notes that there are a number of non-limiting examples of appropriate criteria to use in determining when to stop an assisted classification from Bob 504 to Alice 502, thereby halting or ending the confidence score interchange between Bob 504 and Alice 502. One example stop criterion establishes a maximum threshold for iterative assistance where a round of assisted learning is repeated K times until r̅(A)≤1/K. Another example stop criterion is to use a cross-validation technique until Alice 502's average out-sample predictive error or loss no longer decreases. A third stop criteria directs assisted learning protocol 500 to stop the assisted classification when a weighted mean reward r̅(A) or r̅(B) is close to 1. The third stop criteria may be satisfied when 1) Alice 502's model 502B's predictive performance is extremely good; and 2) some samples have substantial confidence scores.

Techniques for computing the out-sample loss can be found in (e.g., Section 4.3 of) non-patent literature entitled. “Assisted Learning: A Framework for Multi-Organization Learning,” which has been incorporated in its entirety.

As another example, Alice 502 and Bob 504 may train/evaluate their local models 502B and 504B by minimizing the weighted in-sample training loss with a specified model class (i.e., minimization problem). Selecting an appropriate loss function may impact the performance to at least a non-trivial extent. There are a number of example loss functions of which each is capable of solving the minimization problem (e.g., in terms of empirical risk and reward) including the negative log-likelihood loss, cross-entropy loss and Hyvarinen loss functions. In some examples, each agent may solve the minimization problem by (e.g., privately) specifying an appropriate minimization loss function to use.

The training process or the evaluation process may still be inefficient and perform poorly if an agent, such as Alice 502, cannot start the new assistance until all other agents finish one round of information interchange; moreover, the algorithm is not robust enough when the information interchange is interrupted between two agents. Assisted learning protocol 500 may implement a mechanism to halt a training process in the learning stage or an evaluation process in the prediction stage in order to restart the assisted classification.

In other examples, the initial label set may be provided by alternative means, such as another module in example architecture 100 (e.g., a user module providing labels in a query). In general, the initial label set may be generated by any module desiring assisted learning, which, in some instances, may be computing device 200 operating as a user module or a service module or another computing device in a same architecture.

Although model 502B and/or model 504B may configured to be a feedforward neural network, any other machine learning construct may be implemented instead in the context of assisted learning protocol 500. Model 502A may be a three-layer feedforward neural network with Alice 502's parameters and Bob 504's parameters.

To illustrate by way of an example implementation of assisted learning protocol 500, agent 1 may represent a digital marketing company targeting appropriate audience(s) for certain products and agents 2, . . . , m represent a variety of other organizations including different companies. While the digital marketing company may record observations of online customers, agent 1 is limited with respect to variables (e.g., features) and often, find the available observation data to be insufficient for accurate prediction. For instance, the digital marketing company may have online shopping data but do not have other dimensions of shopping data, such as brick and mortar shopping data, to accurate predict which customers are mostly likely to pay for a particular product.

The other organizations provide insight from their observations to benefit the digital marketing company in making accurate predictions. Instead of a fixed ordering of agents, some examples of agent 1 apply a mechanism to determine an altered ordering such as an ordering of agents most likely to result in a highest improvement to the local model. This ordering may omit an agent from the altered ordering if that agent fails to meet a threshold level of assistance for which a number of metrics are applicable. There are a number of way to introduce, into a learner unit of agent 1, functionality for selecting, from available agents, a subset of agent or agents in order of expected reward to agent 1's model. The Order-Greedy version of the training process is an example of an algorithm configured to determine an appropriate ordering having a highest expected reward.

In a context of the above example, the digital marketing company finds the best source of shopping data and eliminate any agent that does not provide useful data. At each iteration, the learner unit of agent 1 selects an ordering of contributors and that ordering may change in subsequent iterations. In some examples, there may be specific for agent 1 to seek assistance in training its local model. There may be specific samples (e.g., customers) that agent 1 would like to train in particular. There may be another agent with its own local model and private data; and if that model and/or data is especially insightful into a particular sample (e.g., customer's purchases of a competitor product) or samples, agent 1 may desire that model/data to train the local model even though the other agent desires privacy (e.g., objective privacy, data privacy, model privacy, differential privacy, and/or the like). By employing a compatible assisted learning protocol as described herein, agent 1 does not need the other agent's model/data to improve the training process.

In a scenario where the digital marketing company has private data for a population, such as a 1,000,000 residents in a state, and other companies have private data for the same population, the digital marketing company may desire to enhance its observations of the online customers with other shopping behavior to target the proper audience for particular products. Some of other companies have a potential to help this digital marketing company to make more accurate predictions, but some have no potential or do not properly pursue their potential. The machine learning task here is to predict who are the most likely customers to pay for a particular product. Each label is one out of K classes specifying different likelihood probabilities. Private data include the private observations held by different companies, this task, and any feature extracted from the private observations concerning specific product data variables and/or specific customer data variables.

Some companies record web browser activity and/or web page statistics. Some companies maintain customer data for their own products. Some companies provide online shopping platforms, and these platforms maintain databases of product sales and their associated customer purchases. Different companies have different levels of private data, and none want to sell their data. One purpose underpinning the present disclosure is better and more security/privacy. The other companies do not have to risk their proprietary assets by transmitting any data publicly (e.g., online) and retain their private data locally while providing the other companies with assistance.

There are alternative applications in which the digital marketing company leverages the assisted learning protocol in some manner. The company may outsource some information to a contributor to perform tasks including the task being predicted by the digital marketing company's trained model. The local model may seek assistance from agents who also use the contributor or who use comparable contributors to determine if this contributor actually provides value, if the contributor does not provide value, the marketing company may save money and other resources by not employing that contributor and possibly employing another (e.g., better) contributor.

Each agent may establish privacy requirements including some combination of the above-mentioned objective privacy, data privacy, model privacy, and/or differential privacy. Different privacy requirements may influence agent 1's learner unit. For instance, a platform may implement the assisted learning protocol amongst agents 1, . . . , m and allow an agent x to provide access to their local model while securing (e.g., hiding a data volume storing) agent x's private data to maintain data privacy.

There are other examples where an organization may employ the assisted learning protocol described herein. Agent 1 may represent a country (e.g., government executive or agency such as the Internal Revenue Service (IRS)) and coordinate some global activity (e.g., coordinate investigation of financial crimes). In a multi-agent scenario, the agents represent different organizations and agent 1, representing University A, employs the assisted learning protocol to find students to recruit including how much to provide in financial help. The other agents may be other universities as well as non-educational organizations. In this manner, University A makes efficient use of its resources and maximizes the quality of the student body.

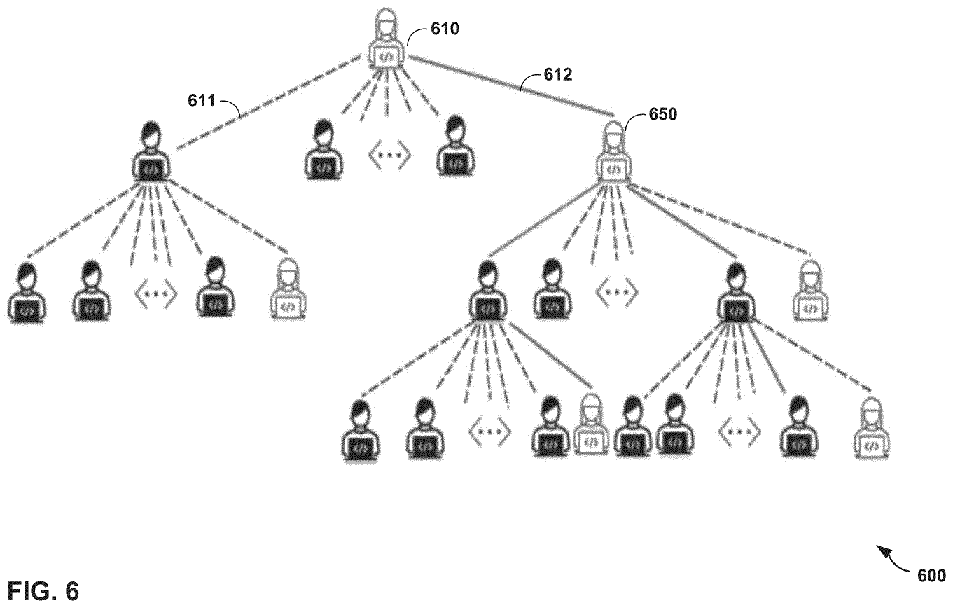

FIG. 6 is an illustration of a multi-agent example for example architecture of FIG. 1A or 1B, in accordance with one or more techniques of the disclosure. As illustrated in the multi-agent example of FIG. 6, tree structure 600 is an embodiment of the example architecture where a number of agents implement a training process according to a version of the Order-Greedy training process. This is in contrast to Algorithm 1.

A training process according to Algorithm 1 introduces exchanges of confidences scores between agents over a number of iterations. Agent 1 as described herein may implement a training process with agents 2, . . . , m. An assistance order at each iteration of information interchange between M agents may be fixed as 1, 2 . . . . , M. There are number of ways a fixed ordering can result in early termination, inefficient training, and/or substandard assistance towards training a local model. The Order-Greedy training process enables dynamic ordering of agents who provide assistance (e.g., in real-time) and in some instances, allows omission of any agent from the assistance order.

Similar to other learning techniques, the Order-Greedy technique described herein includes both the training process and an evaluation process. Between the multiple agents (e.g., M agents), tree structure 600 captures the interchange of statistical information for an assisted learning protocol where root node 610 represents agent 1. As described herein, the statistical information may include sample weights referred to as confidence scores and, in some instances, a model weight for fitting a label set (e.g., a machine learning model) into an observed set of labels. Agent 1 may generate a first model to include a mapping between a set of samples (e.g., a feature set) and the above set of labels, send statistical information comprising a set of sample weights in an iteration of confidence scores for a second model being trained by a second agent and then, receive second statistical information comprising, for a next iteration, a model weight for a third model and a set of sample weights for the model of Agent 1. The tree structure includes nodes, edges, and branches. The above statistical information is interchanged successively in each branch, and the confidence scores are saved on the bottom of the branch for further assistance.

In some examples, the Order-Greedy training process (e.g., in a parallel process) discovers multiple branches for which every node with its parent branch is considered as a candidate branch. FIG. 6 depicts candidate branch 611 and candidate branch 612 among a plurality of possible branches. It may be that candidate branch 611 and candidate branch 612 are in need of assistance and the other branches include agents that are not in need of assistance. For a first step of searching and training multiple branches as candidates, the training process performs an iteration of assisted learning in accordance with each branch by sending confidence scores to all agents. In turn, the agents update and save local information on a node. In one example, the agents 2, . . . . M coordinate with agent 1 and follow the sample tree structure. As for the second step of selecting candidate(s), the Order-Greedy training process chooses candidate branches who yield the highest validation accuracy. FIG. 6 depicts sub-tree 650 to include the chosen candidate branch and its assistance ordering of agents. As for the third step, the selected branches will be considered as new parent branches, who will discover further assistance.

There are a number of advantages to the above technique of which a first advantage is high efficiency. If the number of agents involved in each assistance branch is 7, a traditional way that goes over all possible combinations will have the computation cost at the order of MT. At each discovery, agent 1 only selects branches that yield the top validation performance. The Order-Greedy process, however, can reduce the computation cost at the order of MT. The second advantage is high robustness. If one branch breaks down, other branches still continue searching until meets the stop criteria. The third advantage is easy management and economical budget, the agent 1 decides the candidates, and only buys service from the selected branches.

The following provide details of an example Order-Greedy training process that can be (e.g., programmed into) executable logic for a computing device. The first step includes initialization sub-step in which the computing device of agent 1, denoted by time t=0, is to initialize the information on a parent branch Q_{1,1}. For a number of iterations t, a parent branch Q_{t,b} is defined as a branch that needs further assistance with nodes and a history branch H_{t,b} is defined as a saved branch whose local machine learning model is sufficiently trained and needs no further assistance.

In an example where agent 1 needs assistance from agent(s) 2, . . . , m and derives a dataset combining g_{t,1}⁽¹⁾, r_{t,1}⁽¹⁾, α_{t,1}⁽¹⁾ where g_{t,1}⁽¹⁾ represents a local machine learning model being trained by agent 1 at iteration t, r_{t,1}⁽¹⁾ represents a reward vector indicating a progress in training the local machine learning model, and α_{t,1}⁽¹⁾ represents a model weight from fitting, into an observed label set Y, a label set g(X) generated by the local machine learning model from a feature set X. As described herein, the feature set and the label set correspond to a sample and a predicted label for that sample. In some examples, the model weight at (e.g., initialization) time t=0, α_{0,1}⁽¹⁾, is given an initial value set to any random (e.g., positive) value.

In accordance with the Order-Greedy training process, agent 1 computes initial confidence scores w and v for the parent branch Q_{1,1}. In one example, agent 1 initialize w and v to a value computed from n⁻¹ where n represents a total number of labels in the label g(X) set and then, determines the reward vector r by minimizing in-sample loss as directed by Algorithm 2. In one example, agent 1 fits the local model g and the reward vector r into the observed label set Y as part of the training (for one iteration). Agent 1 may use the reward vector r to update the model weight α_{0,1}⁽¹⁾ using equation (15). Using the model weight, agent 1 updates the confidence scores w and v and determines second confidence scores for transmission to a second agent (agent 2) where a second machine learning model is being trained.

An m^{th} agent (agent m) under the above parent branch, upon receiving the m^{th} confidence scores from agent m−1, proceeds to train a local model g_{0,1}^{(m)} for agent m−1. Agent 1 may commence a next iteration of the training process by receiving from agent m, an m^{th} model weight and updated confidence scores for training the local machine learning model g_{0,1}⁽¹⁾.

For example, agent 2 may implement Algorithm 2 to determine a mapping between a second feature set and a second label set for the second model g_{0,1}⁽¹⁾ based on a second reward vector indicative of a progress level in training the second model. As directed by Algorithm 2, agent 2 uses a second model weight to fit the second label set into the observed label set. Agent 2 proceeds to update the second model weight based on the reward vector. Based on the second model weight and the second confidence scores, agent 2 computes third confidence scores for training a third model at a third agent (agent 3) or, as an alternative, returns to agent 1 a dataset combining the second model weight and a next iteration of the confidence scores for the local model at agent 1. The third confidence scores and/or the updated confidence scores are determined from the second confidence scores and the second model weight as demonstrated in equations (16) and (17).

In some examples, at each time t, the Order-Greedy learning technique is divided into three steps of the above training process, an evaluation process, and a process for selecting, saving, and updating a branch. In one example, the evaluation process implements a Predicted Ensemble Accuracy (PEA) algorithm for which input data includes a set of parent branches. As demonstrated in Algorithm 5 of page 22, the PEA algorithm produces a prediction class pi and a prediction accuracy r. Note that the upcoming data X(m) that is privately owned by agent m.

The PEA algorithm is described in detail (e.g., as Algorithm 5) in non-patent literature entitled, “Assisted Learning: A Framework for Multi-Organization Learning,” which has been incorporated in its entirety. For each label in the label set generated by agent 1, there are K possible classes of expected labels. The PEA algorithm predicts an expected class as pi based on which one(s) of the K classes yields the largest ensemble prediction result among all classes as described in (e.g., equation (23) as defined for Algorithm 5 in the non-patent literature). At validation sub-step of the evaluation process, agent 1 outputs the prediction accuracy if the input class c is not empty in accordance with the PEA algorithm. The evaluation process of the Order-Greedy technique chooses the top B branches from candidates.

In some examples of the third stage, agent 1 chooses the top B branches that yield the highest validation accuracy, and denotes the set of selected branch(s) as Sₜ. The Order-Greedy then updates the parent branch Q_{t,b} and the history branch H_{t,b}. Note that the parent branch is selected from Sₜ, and it might achieve better performance by further discovering assistance. If the current parent branch is in Sₜ then, the current branch might need no more assistance. The Order-Greedy technique then updates the confidence scores for the selected branches. For one or more remaining iterations, the above technique is repeated until satisfying any one of the stopping rules described herein.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method comprising:
by processing circuitry of a computing device, sending first statistical information from a first agent to a second agent in an architecture having at least two agents, wherein a first machine learning model is configured to map a first feature set to a first label set and the first agent is configured to train the first machine learning model to predict an observed label set, wherein a first set of sample weights correspond to training the first machine learning model, wherein the first set of sample weights determine a first model weight for fitting the first label set with the observed label set based on a first learning technique and the first machine learning model, wherein the first set of sample weights and the first model weight determine a second set of sample weights corresponding to training a second machine learning model at the second agent, wherein the first statistical information comprises the second set of sample weights,
wherein the second agent receives the first statistical information comprising the second set of sample weights and comprises the second machine learning model configured to map a second feature set to a second label set,
wherein the second agent is configured to determine a second model weight for fitting, into the observed label set, the second label set based on a second learning technique, the second machine learning model, and the first statistical information, wherein the second agent is further configured to update the first set of sample weights based on the second model weight and the second set of sample weights, wherein the second agent executes on at least one computing system;
by the processing circuitry of the computing device, receiving, from the second agent, second statistical information comprising the second model weight and the updated first set of sample weights or, from a third agent of the architecture, third statistical information comprising a third model weight and a next iteration of the first set of sample weights, wherein the third model weight is derived from the first statistical information and the second statistical information; and
updating, by the processing circuitry of the computing device, the first machine learning model using the second statistical information or the third statistical information, wherein the updated machine learning model is configured to map the first feature set to an updated first label set based on the updated first set of sample weights or the next iteration of the first set of sample weights.

2. The method of claim 1 further comprising sending, by the processing circuitry of the computing device, to the second agent or a fourth agent in the architecture, fourth statistical information defined by an updated first model weight for fitting, into the observed label set, the updated first label set using the first learning technique, wherein the fourth statistical information comprises an updated second set of sample weights based on the updated first model weight and the updated first set of sample weights or the next iteration of the first set of sample weights.

3. The method of claim 2, wherein sending the fourth statistical information further comprises updating, by the processing circuitry, the first model weight into the updated first model weight based on the second model weight or the third model weight.

4. The method of claim 1, further comprising:
generating, based on the updated machine learning model, a predicted label set for a new feature set.

5. The method of claim 4, further comprising:
generating a first prediction label vector based on the updated machine learning model and a feature vector of a new sample in the new feature set;
querying the second agent in the architecture for a second predicted label vector based on the feature vector of the new sample or a partially aligned feature vector of the new sample; and
combining the first predicted label vector with the second predicted label vector into a final predicted label vector.

6. The method of claim 5, wherein a learner unit the first machine learning model comprises a network ensemble in which a neural network is configured to combine the first predicted label vector with the second predicted label vector into the final predicted label vector.

7. The method of claim 1, further comprising:
repeating the sending and the receiving until an out-sample error satisfies a criterion, wherein the out-sample error is computed by cross-validation.

8. The method of claim 1, wherein sending the first statistical information further comprises determine the first model weight to minimize an in-sample prediction loss associated with the first machine learning model.

9. The method of claim 1 further comprising:
creating, by the processing circuitry, a learner unit for the first agent by fitting, into a fitted label set, an initial label set based on the first machine learning model and the first feature set, wherein the learner unit is configured with the first learning technique to generate the first label set to comprise the fitted label set, wherein the first machine learning model is configured to generate a mapping between the first feature set and the initial label set.

10. The method of claim 1 further comprising modifying an ordering of multiple agents of the architecture based on performance information.

11. A computing device for an agent of an assisted learning architecture comprising:
processing circuitry coupled to memory and configured to:
execute a training process on a machine learning model by exchanging, with at least one other agent of the assisted learning architecture, confidence scores over a number of iterations, wherein the at least one other agent is configured to train at least one other machine learning model, wherein for each iteration,
the training process determines a set of sample weights as the confidence scores for the machine learning model and communicates, to a second agent of the at least one agent, a second set of sample weights as the confidence scores for a second machine learning model of the at least one other machine learning model, wherein the confidence scores for the machine learning model corresponds to a progress level in the training process and the confidence scores for the second machine learning model correspond to a progress level in training the second machine learning model when compared to the progress level in training the machine learning model, and
the second agent updates the set of sample weights in response to further training the second machine learning model and returns, to the agent for a next iteration of the confidence scores for the machine learning model, the updated set of sample weights and a model weight determined from the confidence scores of the second machine learning model.

12. The computing device of claim 11, wherein the processing circuitry is further configured to:
execute an evaluation process to apply the trained machine learning model to a feature set to generate a first predicted label set, query the at least one agent to return at least one second predicted label, and generate a final predicted label set based on the first predicted label set and the at least one second predicted label set.

13. The computing device of claim 11, wherein to execute the training process, the processing circuitry is further configured to:
output the trained machine learning model in response to a determination that an iteration of the confidence scores satisfies a threshold for the confidence score.

14. The computing device of claim 11, wherein the agent and the at least one agent implement centralized feature datasets or decentralized feature datasets.

15. The computing device of claim 11, wherein the processing circuitry is further configured to:
terminate the training process in response to determining that an out-sample error satisfies a criterion, wherein the out-sample error is computed by cross-validation.

16. The computing device of claim 11, wherein the processing circuitry is further configured to:
determine the model weight to minimize an in-sample prediction loss associated with the machine learning model.

17. A method performed by processing circuitry, the method comprising:
creating a learner unit comprising a first machine learning model configured with a first learning technique, wherein the learner unit uses the first learning technique to train the first machine learning model to map a first feature set to a first label set based on confidence scores for samples in the first feature set and generates a model weight for fitting, into a task label set, a dataset combining the first feature set and the first label set;
sending, to a second learner unit of a second computing device, second confidence scores for samples in a second feature set used by the second learner unit in training a second machine learning model with the task label set using a second learning technique, wherein the second confidence scores are computed from the model weight and the confidence scores for the samples in the first feature set, wherein the second learning technique generates a second model weight for fitting, into the task label set, a dataset combining the second feature set, a second label set, and the second confidence scores;
receiving, from the second learner unit of the second computing device, the second model weight and a next iteration of the confidence scores defined by the second model weight and the second label set; and
updating the machine learning model using the first learning technique, wherein the updated machine learning model is configured to map the first feature set to a third label set based on the next iteration of the confidence scores and the second model weight.

18. The method of claim 17, wherein the updated machine learning model is configured to map the first feature set to the task label set based on the next iteration of the confidence scores and the second model weight.

19. The method of claim 17, wherein updating the machine learning model further comprises based on the next iteration of the confidence scores, modifying a corresponding label of the first label set for a sample of the first feature set in satisfaction of a threshold.

20. The method of claim 17, wherein non-transitory, computer-readable medium comprising executable instructions, which when executed by processing circuitry, cause a computing device to perform the steps of the method.
